(19) United States
(12) Patent Application Publication
(10) Pub. No.: US 2010/0123792 A1
(43) Pub. Date: May 20, 2010

(54) IMAGE PROCESSING DEVICE, IMAGE PROCESSING METHOD AND PROGRAM

(76) Inventors: Takefumi NAGUMO, Kanagawa (JP); Jun Luo, Tokyo (JP); Yuhi Kondo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/622,191

(22) Filed: Nov. 19, 2009

(30) Foreign Application Priority Data
Nov. 20, 2008 (JP) P2008-296336

(51) Int. Cl. H04N 5/228

(52) U.S. Cl. 348/222.1; 348/E05.022

(57) ABSTRACT

An image processing device, which includes: super-resolution processing executing section which inputs a low-resolution image and a super-resolution image and generates a difference image which represents a difference between the input images; and an adding section which adds the difference image and the super-resolution image, wherein super-resolution processing executing section includes a motion vector detecting section which detects a object-based motion vector which represents a motion between images of an object commonly included in the low-resolution image and the super-resolution image on an object basis, and generates the difference image using a motion-compensated image generated by applying the detected object-based motion vector to each object area.

### BACKGROUND OF THE INVENTION

1. Field of the Invention

The present invention relates to an image processing device, an image processing method and a program. More particularly, the invention relates to an image processing device, an image processing method and a program which perform super-resolution processing to increase image resolution.

2. Description of the Related Art

Super-resolution processing has been proposed as a technique for generating a super-resolution image from a low-resolution image. Super-resolution processing is processing for obtaining a pixel value of a pixel which constitutes one frame of a super-resolution image from plural overlapped low-resolution images.

With super-resolution processing, a super-resolution image having a resolution greater than that of an image sensor can be obtained from, for example, an image captured by an image sensor, such as a charge coupled device (CCD) and a complementary metal oxide semiconductor (CMOS). In particular, super-resolution processing is applied for generating, for example, a super-resolution satellite photograph. Super-resolution processing is described in, for example, “Improving Resolution by Image Registration”, MICHAL IRANI AND SHMUEL P ELEG, Department of Computer Science, The Hebrew University of Jerusalem, 91904 Jerusalem, Israel, Communicated by Rama Chellapa, Received Jun. 16, 199; accepted May 25, 1990.

A principle of super-resolution processing will be described with reference to FIGS. 1 and 2. Symbols a, b, c, d, e and f illustrated in the upper part of FIG. 1(1) and FIG. 1(2) are pixel values of the super-resolution (SR) image to be obtained from a low-resolution (LR) image acquired by photographing an object. That is, the symbols represent the pixel values of the pixels when the object is converted into a pixel image at the same resolution as that of the SR image.

For example, the width of one pixel of the image sensor corresponds to two pixels that correspond to the object and therefore an image of the object is not captured at the intended resolution, a pixel value A obtained by combining the pixel values a and b for the left pixel of the three pixels of the image sensor is set as illustrated in FIG. 1(1). A pixel value B obtained by combining the pixel values c and d is set for the central pixel. A pixel value C obtained by combining the pixel values e and f is set for the right pixel. A, B and C represent the pixel values of the pixels constituting the photographed LR image.

An image of the object whose position has shifted due to a shift operation or blurring by a distance of a half pixel corresponding to the object as shown in FIG. 1(2) is captured together with an image of the object in its original position in FIG. 1(1), with the position of the object in FIG. 1(1) as a reference. In this case (i.e., if an image of the object is captured during such shifting), a pixel value D obtained by combining a half of the pixel value a, the pixel value b and a half of the pixel value c is set for the left pixel of the three pixels of the image sensor. A pixel value E obtained by combining a half of the pixel value c, the pixel value d and a half of the pixel value e is set for the central pixel. A pixel value F obtained by mixing a half of the pixel value e and the pixel value f is set for the right pixel. D, E and F also represent pixel values of pixels which constitute the photographed LR image.

The following equation, Equation 1, is obtained from a photographing result of such an LR image. An image having a resolution higher than that of the image sensor can be acquired by obtaining a, b, c, d, e and f from Equation 1.

$$( \begin{matrix}1 & 1 & 0 & 0 & 0 & 0 \\ 0 & 0 & 1 & 1 & 0 & 0 \\ 0 & 0 & 0 & 0 & 1 & 1 \\ 1 / 2 & 1 & 1 / 2 & 0 & 0 & 0 \\ 0 & 0 & 1 / 2 & 1 & 1 / 2 & 0 \\ 0 & 0 & 0 & 0 & 1 / 2 & 1\end{matrix} ) ( \begin{matrix}a \\ b \\ c \\ d \\ e \\ f\end{matrix} ) = ( \begin{matrix}A \\ B \\ C \\ D \\ E \\ F\end{matrix} ) \qquad Equation 1$$

Back projection super-resolution processing, which is related art super-resolution processing, will be described with reference to FIG. 2. Super-resolution processing section 1 illustrated in FIG. 2 is incorporated in, for example, a digital camera, and processes photographed still images.

As illustrated in FIG. 2, super-resolution processing section 1 includes super-resolution processing executing sections 11a to 11c, a summing section 12, an adding section 13 and an SR image buffer 14. For example, a photographed low-resolution LR image LR0 is input into super-resolution processing executing section 11a, and a low-resolution image LR1 is input into super-resolution processing executing section 11b. A low-resolution image LR2 is input into super-resolution processing executing section 11c. The low-resolution images LR0 to LR2 are continuously photographed images and have overlapping portions in the photographed area. If the images are photographed continuously, the objects in the photographed images are usually slightly misaligned with one another due to, for example, blurring and thus are not completely aligned with each other and partly overlap one another.

Super-resolution processing executing section 11a generates a difference image representing a difference between the low-resolution image LR0 and the super-resolution image stored in the SR image buffer 14 and outputs a feedback value to the summing section 12. The feedback value is a value representing a difference image having the same resolution as that of the SR image.

The SR image buffer 14 stores an SR image which is a super-resolution image generated by super-resolution processing executed most recently. When the process has just started and no frame of the SR image has been generated yet, the low-resolution image LR0, for example, is upsampled to an image having the same resolution as that of the SR image, and the acquired image is stored in the SR image buffer 14.

Similarly, super-resolution processing executing section 11b generates a difference image representing a difference between the low-resolution image LR1 and the super-resolution image stored in the SR image buffer 14 and outputs a feedback value representing the generated difference image to the summing section 12.

Similarly, super-resolution processing executing section 11c generates a difference image representing a difference between the low-resolution image LR2 and the super-resolution image stored in the SR image buffer 14 and outputs a feedback value representing the generated difference image to the summing section 12.

The summing section 12 averages feedback values supplied from super-resolution processing executing sections 11a to 11c and outputs an image of the same resolution as that of the SR image obtained by the averaging to the adding section 13. The adding section 13 adds the SR image stored in the SR image buffer 14 and the SR image supplied from the summing section 12 and outputs an acquired SR image. Output of the adding section 13 is supplied to the outside of the image processing device 1 as a result of super-resolution processing and is also supplied to and stored in the SR image buffer 14.

FIG. 3 is a block diagram illustrating an exemplary configuration of super-resolution processing executing sections 11a to 11c. As illustrated in FIG. 3, super-resolution processing executing section 11 includes a motion vector detecting section 21, a motion-compensation processing section 22, a downsampling processing section 23, an adding section 24, an upsampling processing section 25 and a reverse motion compensating section 26.

A super-resolution image read from the SR image buffer 14 is input into the motion vector detecting section 21 and the motion-compensation processing section 22. A photographed low-resolution image LRn is input into the motion vector detecting section 21 and the adding section 24.

The motion vector detecting section 21 detects a motion vector (MV) with the SR image as a reference image on the basis of an SR image which is an input super-resolution image and a low-resolution image LRn, and the detected motion vector (MV) is output to the motion-compensation processing section 22 and the reverse motion compensating section 26. A vector representing a shift in the position of each block of the SR image in a newly input LRn image is generated by, for example, block matching of an SR image generated on the basis of an image photographed in the past and a newly input LRn image.

The motion-compensation processing section 22 performs motion compensation on a super-resolution image on the basis of the motion vector supplied from the motion vector detecting section 21 and generates a motion-compensated (MC) image. The generated motion-compensated image (MC image) is output to the downsampling processing section 23. The motion-compensation process is a process for moving a pixel position of the SR image on the basis of the motion vector and generating a corrected SR image having a position corresponding to the newly input LRn image. That is, the pixel position of the SR image is moved to generate a motion-compensated image (MC image) in which the position of the object in the SR image is aligned with the position of the object in the LRn.

The downsampling processing section 23 generates an image of the same resolution as that of the LRn by downsampling the image supplied from the motion-compensation processing section 22 and outputs the generated image to the adding section 24. Obtaining a motion vector from the SR image and the LRn and acquiring an image motion-compensated by the obtained motion vector to be an image of the same resolution as that of the LR image corresponds to simulating a photographed image on the basis of the SR image stored in the SR image buffer 14.

The adding section 24 generates a difference image which represents a difference between the LRn and a thus-simulated image and outputs the generated difference image to the upsampling processing section 25.

The upsampling processing section 25 generates an image of the same resolution as that of the SR image by upsampling the difference image supplied from the adding section 24 and outputs the generated image to the reverse motion compensating section 26. The reverse motion compensating section 26 performs reverse direction motion compensation to the image supplied from the upsampling processing section 25 on the basis of the motion vector supplied from the motion vector detecting section 21 and outputs the feedback value representing the image obtained by the reverse direction motion compensation to the summing section 12 illustrated in FIG. 2. The position of an object in an image obtained by reverse direction motion compensation is near the position of the object in the SR image stored in the SR image buffer 14.

An exemplary overall structure of the image processing device which executes such super-resolution processing is illustrated in FIG. 4. The image acquired in the photographing section 31, such as the CCD and the CMOS, is subjected to image quality control, such as contrast adjustment and aperture compensation (edge enhancement) in the image quality control section 32, compressed in the image compressing section 33 in accordance with a predetermined compression algorithm, such as MPEG compression and then recorded on a storage medium 34, such as a DVD, a tape or a flash memory.

The image recorded on the storage medium 34 is decoded and subjected to super-resolution processing during reproduction. The image recorded on the storage medium 34 is decoded in the image decoding section 35 and then subjected to super-resolution processing described with reference to FIG. 1 to FIG. 3 in the super-resolution processing section 36 so as to generate a super-resolution image which is displayed on a display section 37.

The image output by super-resolution processing is not limited to a moving image but may be a still image. For the moving image, plural frame images are used. For the still image, continuously photographed still images are used. In continuously photographed still images, areas of the photographed images are shifted slightly due to, for example, blurring. However, a super-resolution image can be generated by super-resolution processing illustrated with reference to FIGS. 1 to 3.

As described with reference to FIG. 3, in super-resolution processing, the motion vector detecting section 21 detects a motion vector with the SR image being a reference image on the basis of the SR image, which is the input super-resolution images, and the LRn image, which is the low-resolution image, and outputs the detected motion vector to the motion-compensation processing section 22 and the reverse motion compensating section 26. The motion-compensation processing section 22 and the reverse motion compensating section 26 perform a process in which the motion vector (MV) input from the motion vector detecting section 21 is applied.

A motion component to be considered at the time of the motion vector calculation process executed in the motion vector detecting section 21 will be described with reference to FIG. 5.

As illustrated in FIG. 5, the motion vector detecting section 21 uses two images 71 and 72, analyzes a motion between these two images and obtains a motion vector. The motion vector can be calculated by various methods. The following different motion vectors are calculated in accordance with the vector calculating method employed: a camera motion-based motion vector 75 corresponding to a motion of the entire image and an object motion-based motion vector 76 corresponding to a motion between images of an object (automobile) 73 within the image.

These two motion vectors 75 and 76 are different in size and in direction. Accordingly, processing results differ between a case where the motion vector output from the motion vector detecting section 21 illustrated in FIG. 3 to the motion-compensation processing section 22 and the reverse motion compensating section 26 is the motion vector 75, and a case where the output vector is the motion vector 76.

A process example will be described in detail with reference to FIG. 6. Two exemplary calculation processes of the motion vector are illustrated in FIG. 6: (1) an exemplary calculation process of a local motion vector (LMV) and (2) an exemplary calculation process of a global motion vector (GMV).

(1) A calculation process of the local motion vector (LMV) is to divide a screen into small areas (i.e., blocks), obtaine motions for each divided areas and execute a process on the area basis by the motion vector on the area basis. For example, an object motion illustrated in FIG. 5 is acquirable by a calculation process of the local motion vector (LMV).

Advantages of the calculation process of the local motion vector (LMV) are that processes can be executed individually on the motions of the objects and the background on the screen. Defects of the LMV calculation, on the contrary, is that the detection precision deteriorates caused by small image areas used for motion detection corresponding to the local motion vector (LMV) of each block. There arises a problem that, when super-resolution processing to which the local motion vector (LMV) is applied is executed, performance degradation of the super-resolution may occur due to precision reduction of the motion vector (MV).

The calculation process of (2) global motion vector (GMV) is, however, a process for obtaining only one motion vector (i.e., a camera motion) of the entire screen for each image. For example, a camera motion illustrated in FIG. 5 is acquired by a calculation process of the global motion vector (GMV).

An advantage of the calculation process of the global motion vector (GMV) is that a high-precision motion vector can be calculated since the entire image is used. A defect of the calculation process of the GMV is that an object motion which is a motion inherent to the object in the image is not able to be detected. A further defect is that, regarding a locally-moving object, since no process to which the object-based motion vector is not made, the motion compensation is not able to be performed. When super-resolution processing to which such a global motion vector (GMV) is applied is performed, regarding the locally-moving object, there is a problem that the effect of the super-resolution effect fails to be exhibited.

As described above, both super-resolution processing to which the local motion vector (LMV) is applied and super-resolution processing to which global motion vector (GMV) is applied have defects.

### SUMMARY OF THE INVENTION

The invention is made in view of the aforementioned circumstances. It is desired to provide an image processing device, an image processing method, and a program which can generate a high-quality super-resolution image through a calculation process of an optimal motion vector to execute a motion-compensation process and super-resolution processing motion-compensation process.

A first embodiment of the invention is an image processing device, which includes: super-resolution processing executing section which inputs a low-resolution image and a super-resolution image and generates a difference image which represents a difference between the input images; and an adding section which adds the difference image and the super-resolution image, wherein super-resolution processing executing section includes a motion vector detecting section which detects an object-based motion vector which represents a motion between images of an object commonly included in the low-resolution image and the super-resolution image on an object basis, and generates the difference image using a motion-compensated image generated by applying the detected object-based motion vector to each object area.

In one embodiment of the image processing device of the invention, super-resolution processing executing section may be configured by a plurality of super-resolution processing executing sections which generate difference images representing differences between a plurality of different low-resolution images and the super-resolution images; and the adding section may add an output of a summing section which adds the super-resolution image and the plurality of difference images output from the plurality of super-resolution processing executing sections.

In one embodiment of the image processing device of the invention, super-resolution processing executing section may further include an object detection section which detects an object included in the super-resolution image and generates object area information that includes a label to identify an object to which each configuration pixel of the super-resolution image belongs; and the motion vector detecting section may detect an object-based motion vector on an object basis by applying the object area information generated by the object detection section.

In one embodiment of image processing device of the invention, super-resolution processing executing section may have an area definition GUI for inputting specification information regarding an area for which super-resolution processing is executed from the super-resolution image; and the motion vector detecting section may detect an object-based motion vector on an object basis by applying area definition information specified via the area definition GUI.

In one embodiment of image processing device of the invention, the motion vector detecting section may include an object-based motion vector calculating section which calculates, on an object basis, an object-based motion vector which represents a motion between images of the object commonly included in the low-resolution image and the super-resolution image and an object-based motion vector refinement section which refines the object-based motion vector calculated by the object-based motion vector calculating section; and the object-based motion vector refinement section may modify a constitution parameter of an object-based motion vector calculated by the object-based motion vector calculating section and generate a modified object-based motion vector, may generate a low-cost modified object-based motion vector through a cost calculation on the basis of a difference between the low-resolution image and a motion-compensated image to which the modified object-based motion vector is applied, and may output the generated low-cost modified object-based motion vector as a vector to be applied in generation of the difference image.

In one embodiment of image processing device of the invention, the image processing device may further include an object-based motion vector inspecting section for inspecting precision of the object-based motion vector generated by super-resolution processing executing section, the object-based motion vector inspecting section may execute, with respect to the super-resolution image, a cost calculation on the basis of a difference between the low-resolution image and a motion-compensated image to which the object-based motion vector generated by super-resolution processing executing section is applied, the object-based motion vector inspecting section determines that the object-based motion vector has allowable precision when cost below a previously set threshold is calculated, and performs to output what as an object to be added in the adding section on the basis of the determination.

In one embodiment of image processing device of the invention, super-resolution processing executing section may generate the difference image using the motion-compensated image generated by applying the object-based motion vector to each object area and generates, when an occlusion area generated by movement of an object exists in the difference image, a difference image with a pixel value 0 set for the occlusion area.

A second embodiment of the invention is an image processing method which executes a super-resolution image generation process in an image processing device, the method including the steps of: executing, by super-resolution processing executing section, super-resolution processing by inputting a low-resolution image and a super-resolution image for generating a difference image that represents a difference between the input images; and adding, by an adding section, the difference image and the super-resolution image, wherein super-resolution processing detects, on an object basis, the object-based motion vector which represents a motion between images of the object commonly included in the low-resolution image and the super-resolution image and generates the difference image by using a motion-compensated image generated by applying the detected object-based motion vector to each object area.

A third embodiment of the invention is a program which causes a super-resolution image generation process to be executed in an image processing device, the process including the steps of: executing super-resolution processing by causing super-resolution processing executing section to input a low-resolution image and a super-resolution image and generate a difference image that represents a difference between the input images; and executing an adding process by causing an adding section to add the difference image and the super-resolution image, wherein the step of executing super-resolution processing includes the steps of: causing detection of, on an object basis, the object-based motion vector which represents a motion between images of the object commonly included in the low-resolution image and the super-resolution image; and causing to generation of the difference image by using a motion-compensated image generated by applying the detected object-based motion vector to each object area.

The program according to an embodiment of the invention is a computer program which can be provided on a storage medium and a communication medium provided, in a computer-readable format, to a general purpose computer system that can execute various program codes, for example. Such a program is provided in a computer-readable format to cause processes in accordance with the program is executed in the computer system.

Other objects, feathers and advantages of the invention will become more apparent as the description proceeds in conjunction with the accompanying drawings. The term “system” used herein is a logical collection of plural devices, which are not necessarily placed in a single housing.

According to a configuration of an embodiment of the invention, in an image processing device which generates a super-resolution image with increased resolution of an input image, a difference image representing a difference between an input low-resolution image and an input super-resolution image, and adds the difference image and the super-resolution image. Super-resolution processing executing section detects, on an object basis, an object-based motion vector which represents a motion between images of an object commonly included in the low-resolution image and the super-resolution image, and generates a difference image by using a motion-compensated image generated by applying the detected object-based motion vector to each object area. According to this configuration, a motion inherent to an object can be reflected on an object area basis, and thus a high-precision super-resolution image can be generated.

### BRIEF DESCRIPTION OF THE DRAWINGS

FIG. 1 illustrates super-resolution processing which generates a super-resolution image from a low-resolution image;

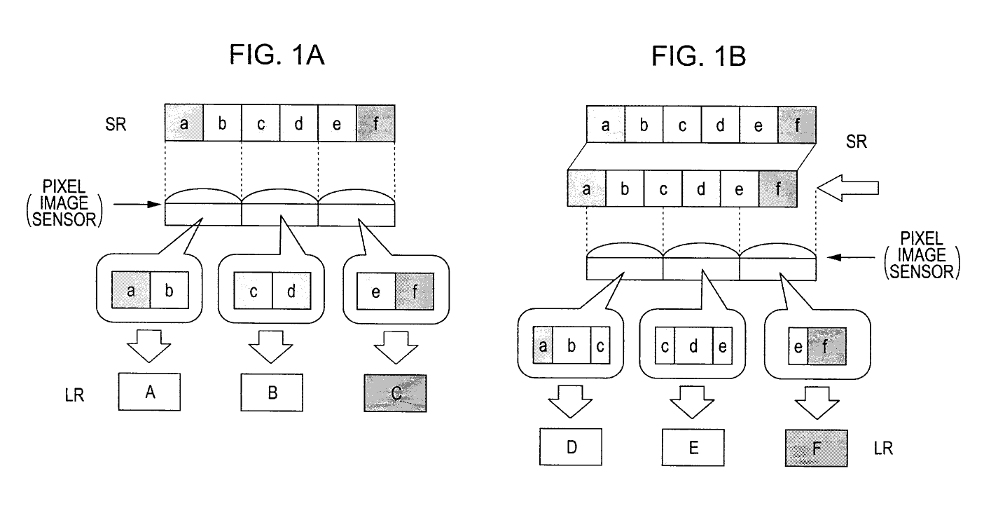

FIG. 2 illustrates an exemplary configuration for executing super-resolution processing which generates a super-resolution image from a low-resolution image;

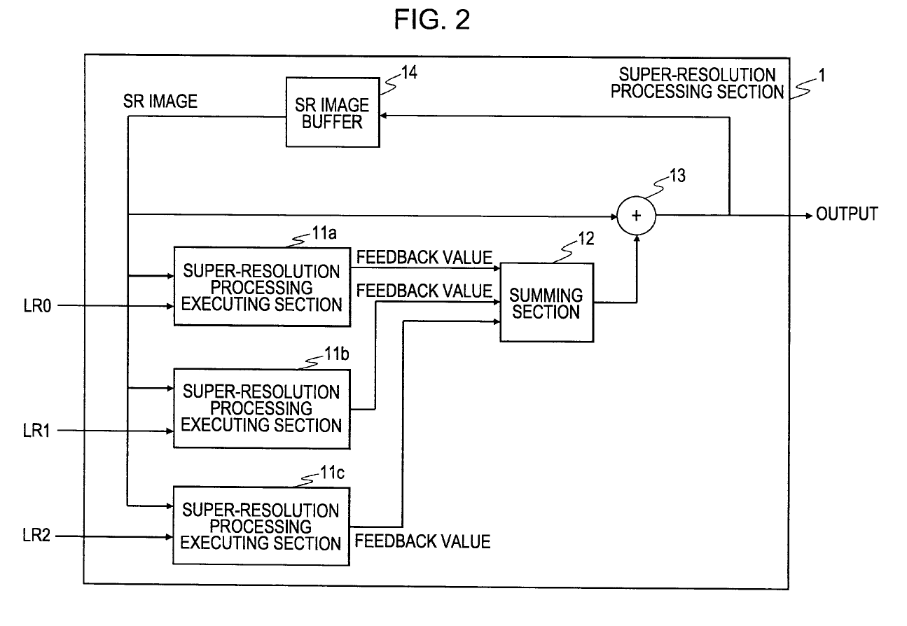

FIG. 3 illustrates an exemplary configuration for executing super-resolution processing which generates a super-resolution image from a low-resolution image;

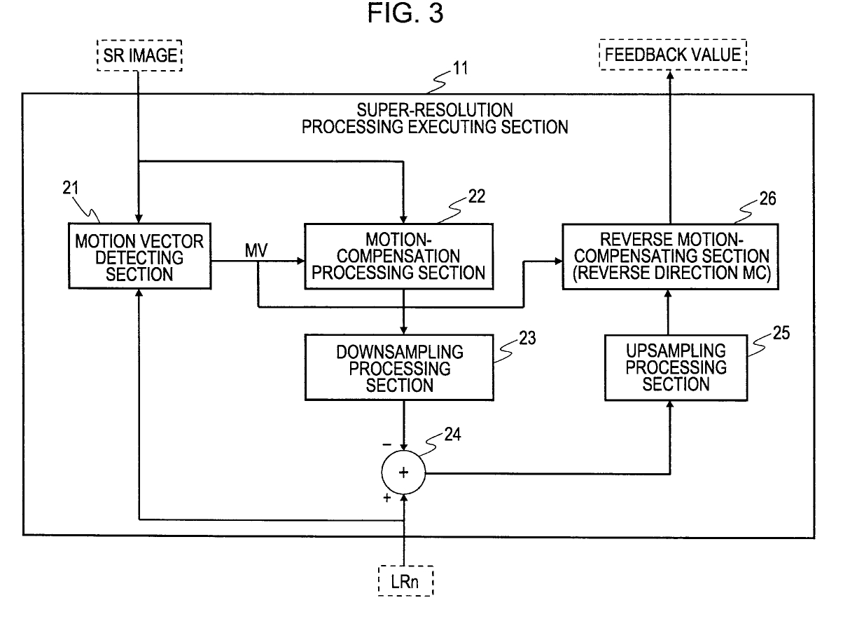

FIG. 4 illustrates an exemplary configuration of an image processing device which performs super-resolution processing;

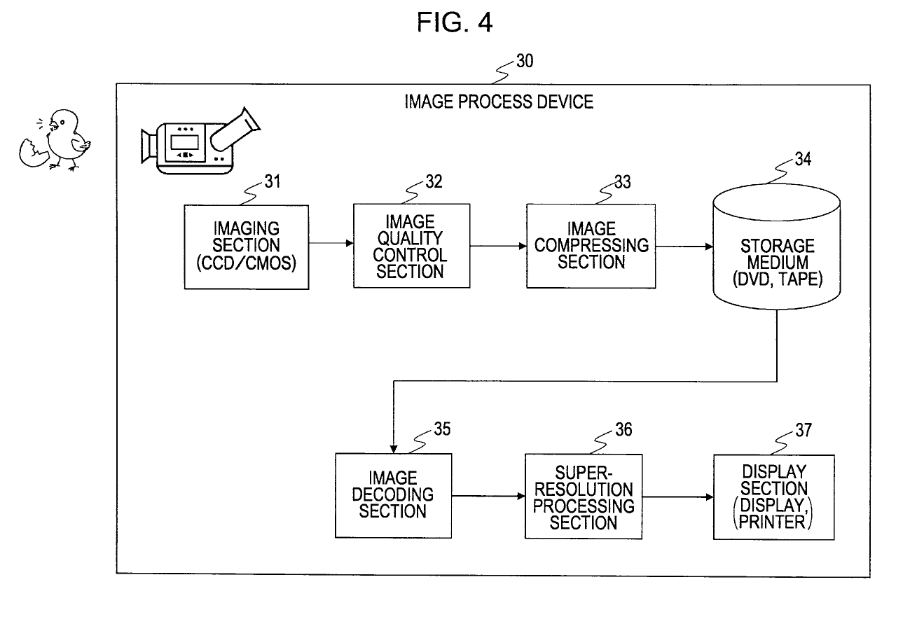

FIG. 5 illustrates a motion component which should be considered in a motion vector calculation process;

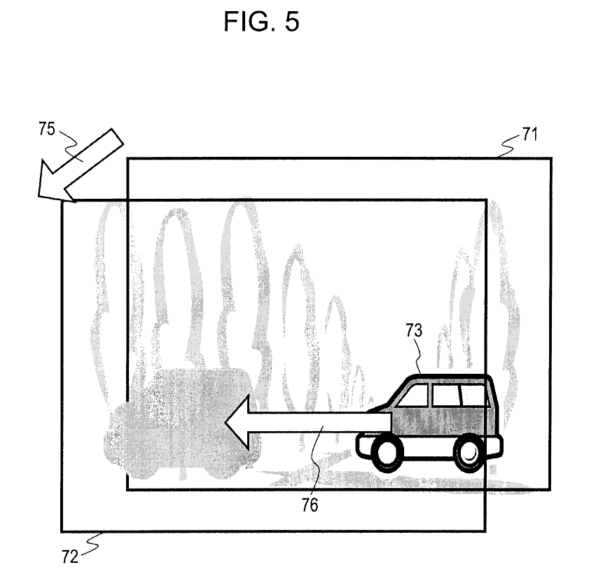

FIG. 6 illustrates an exemplary calculation process of a local motion vector (LMV) and a global motion vector (GMV);

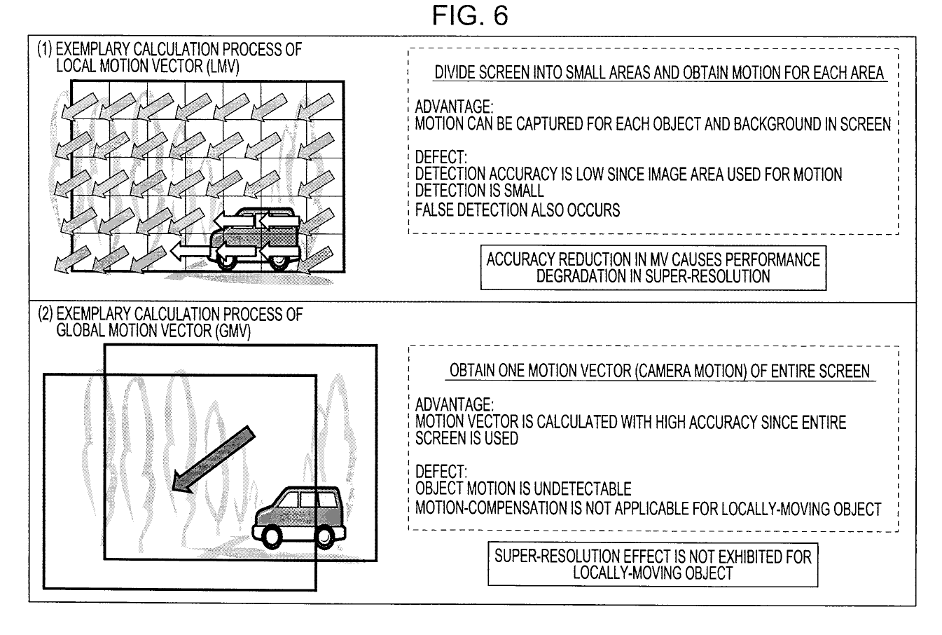

FIG. 7 illustrates an exemplary configuration of an image processing device according to an embodiment of the invention;

FIG. 8 illustrates an exemplary configuration of an image processing device according to an embodiment of the invention;

FIG. 9 illustrates an exemplary configuration of super-resolution processing section according to an embodiment of the invention;

FIG. 10 illustrates an exemplary configuration of super-resolution processing executing section according to an embodiment of the invention;

FIG. 11 illustrates an exemplary configuration of an object detector set in super-resolution processing executing section according to an embodiment of the invention;

FIG. 12 illustrates a process example of an object detector;

FIG. 13 illustrates an exemplary configuration of a motion vector detecting section;

FIG. 14 illustrates an exemplary calculation process of a local motion vector (LMV) calculated by a local motion vector (LMV) calculating section;

FIG. 15 illustrates an exemplary calculation process of an object motion vector (OMV) calculated by an object motion vector (OMV) calculating section 233;

FIG. 16 illustrates a process executed by a motion-compensation processing section in super-resolution processing executing section;

FIG. 17 illustrates a process executed by a reverse motion compensating section in super-resolution processing executing section;

FIG. 18 illustrates a characteristic of super-resolution processing according to a first embodiment of the invention;

FIG. 19 illustrates an exemplary configuration of a motion vector detecting section according to a second embodiment;

FIG. 20 illustrates an exemplary configuration of an OMV refinement section in the motion vector detecting section according to the second embodiment;

FIG. 21 illustrates an exemplary configuration of an OMV refinement process control section in the OMV refinement section in the motion vector detecting section according to the second embodiment;

FIG. 22 illustrates an exemplary configuration of a refined vector generating section in an MV refinement process control section;

FIG. 23 illustrates user selection of super-resolution processing area according to a third embodiment;

FIG. 24 illustrates an exemplary configuration of super-resolution processing section according to the third embodiment;

FIG. 25 illustrates a process example of area definition GUI in super-resolution processing section according to the third embodiment;

FIG. 26 illustrates an exemplary configuration of super-resolution processing executing section according to the third embodiment;

FIG. 27 illustrates an exemplary configuration of an OMV precision check section in super-resolution processing executing section;

FIG. 28 illustrates a characteristic of super-resolution processing according to the third embodiment of the invention; and

FIG. 29 illustrates an exemplary configuration of hardware in an image processing device according to an embodiment of the invention.

### DESCRIPTION OF THE PREFERRED EMBODIMENTS

Hereinafter, the image processing device, the image processing method and the program according to an embodiment of the invention will be described in detail with reference to the drawings.

The description will be given in the following order.

(1) Exemplary Configuration of Image Processing Device

(2) Configuration of Super-Resolution Processing Section and Process Example (First Embodiment)

(3) Embodiment with Object-Based Motion Vector (Omv) Refinement Section (Second Embodiment)

(4) Embodiment which Allows Specification of Area to be Super-Resolved by User (Third Embodiment)

(5) Exemplary Hardware Configuration of Image Processing Device

### (1) Exemplary Configuration of Image Processing Device

The image processing device according to an embodiment of the invention has a configuration which performs super-resolution processing on image data and generates a super-resolution image. The process image may be a moving image or a still image.

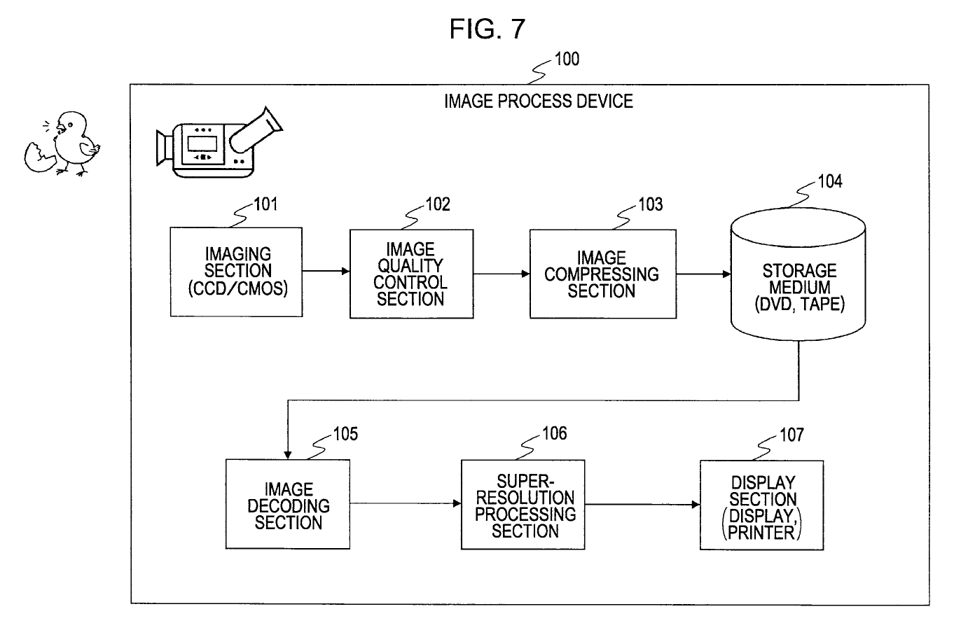

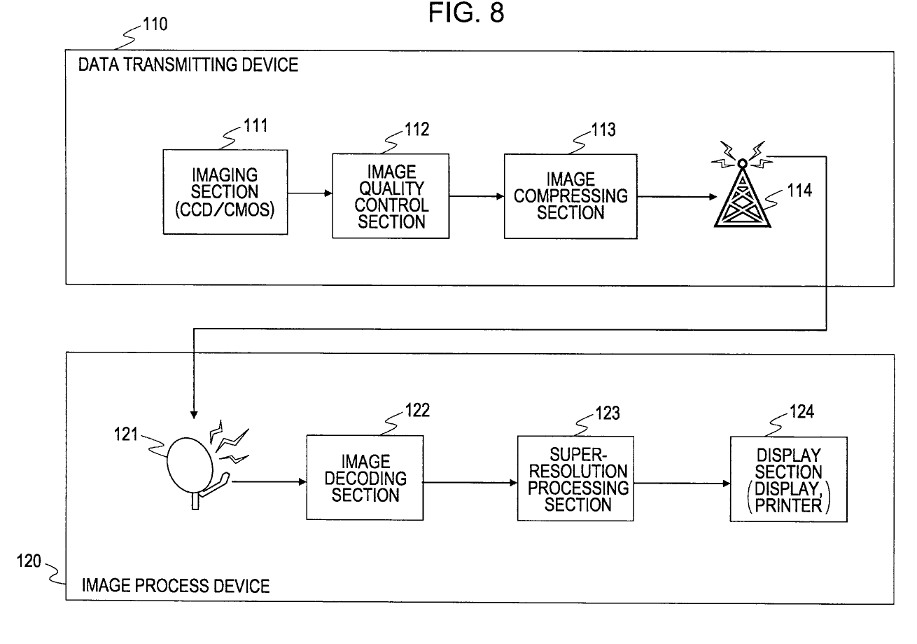

With reference to FIGS. 7 and 8, an exemplary configuration of the image processing device according to the invention will be described. The image processing device illustrated in FIG. 7 is an image processing device 100 which is, for example, a video camera or a still camera. The image acquired in the photographing section 101, such as the CCD and the CMOS, is subjected to image quality control, such as contrast adjustment and aperture compensation (i.e., edge enhancement), in the image quality control section 102. Then, in an image compressing section 103, the image is compressed in accordance with a predetermined compression algorithm, such as MPEG compression, and is recorded on a storage medium 104, such as a DVD, a tape or a flash memory.

The image recorded on the storage medium 104 is decoded and then reproduced, at which point super-resolution processing is executed. The image recorded on the storage medium 104 is decoded in an image decoding section 105. The decoded image is input into super-resolution processing section 106, which performs super-resolution processing and a super-resolution image is generated. The generated super-resolution image is displayed on a display section 107. The display section 107 includes a display device and a printer. The generated super-resolution image subjected to super-resolution processing in super-resolution processing section 106 may be stored in the storage medium 104.

The image processing device 100 illustrated in FIG. 7 has a configuration to corresponding to, for example, a video camera or a still camera. The image processing device 100 can perform super-resolution processing also on a received image of broadcast image data, such as digital broadcast image data, generate and output a super-resolution image at a receiver side. An example illustrated in FIG. 8 illustrates a configuration of a data transmission device 110 which transmits a low-resolution image and an image processing device 120 which receives data from the data transmission device 110, performs super-resolution processing and generates and displays a super-resolution image.

In the data transmission device 110, the image acquired in the photographing sections 111, such as the CCD and the CMOS, is subjected to image quality control, such as contrast adjustment and aperture compensation (edge enhancement) in the image quality control section 112 and is compressed in accordance with a predetermined compression algorithm, such as MPEG compression, in the image compressing section 113 and is transmitted from a transmitting section 114.

The data transmitted from the transmitting section 114 is received in a receiving section 121 of the image processing device 120 and the received data is decoded in an image decoding section 122. Then, the decoded image is input into super-resolution processing section 123. Super-resolution processing section 123 performs super-resolution processing and a super-resolution image is generated and displayed on a display section 124. The display section 124 includes a display device and a printer. The generated super-resolution image subjected to super-resolution processing in super-resolution processing section 123 may be stored in a storage medium.

### (2) Configuration of Super-Resolution Processing Section and Process Example (First Embodiment)

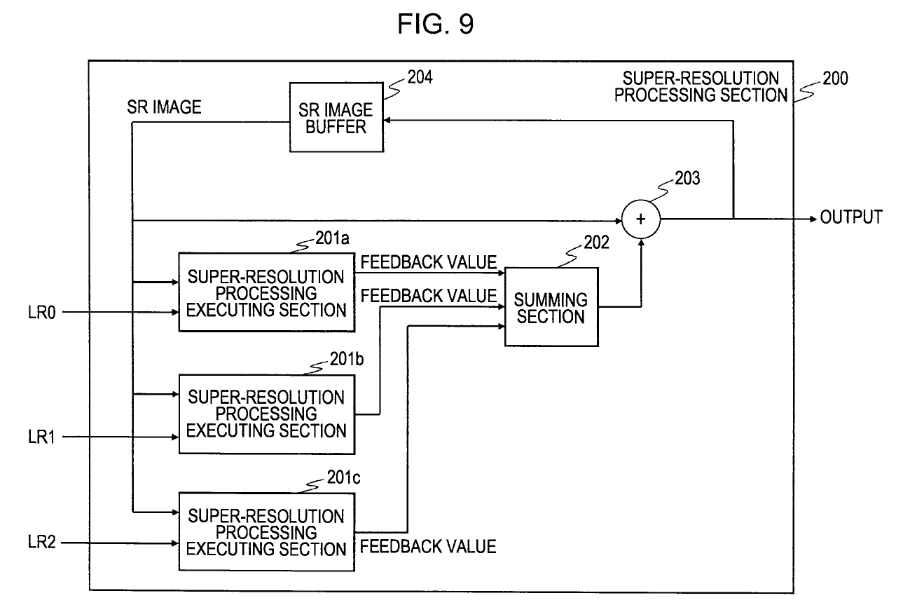

Next, a configuration and a process of super-resolution processing section in the image processing device according to an embodiment of the invention will be described with reference to FIG. 9.

First, the configuration of super-resolution processing section will be described with reference to FIG. 9. Super-resolution processing section 200 illustrated in FIG. 9 corresponds to, for example, super-resolution processing section 106 of the image processing device 100 illustrated in FIG. 7 and super-resolution processing section 123 of the image processing device 110 illustrated in FIG. 8. As illustrated in FIG. 9, super-resolution processing section 200 includes super-resolution processing executing sections 201a to 201c, a summing section 202, an adding section 203 and an SR image buffer 204.

A low-resolution image LR0 which is, for example, a photographed low-resolution image (LR image), is input into super-resolution processing executing section 201a, and a low-resolution image LR1 is input into super-resolution processing executing section 201b. A low-resolution image LR2 is input into super-resolution processing executing section 201c. The low-resolution images LR0 to the LR2 are continuously photographed images, for example, and have overlapped portions in the photographed areas thereof. If the images are photographed continuously, the objects in the photographed images are usually slightly misaligned with one another due to, for example, blurring and thus are not completely aligned with each other and partly overlap one another. It suffices that the input images LR0 to LR2 are not limited to continuously photographed images but may be images having partially overlapping portions.

Super-resolution processing executing section 201a generates a difference image representing a difference between the low-resolution image LR0 and the super-resolution image (SR image) stored in the SR image buffer 204 and outputs a feedback value to the summing section 202. The feedback value is a value representing a difference image having the same resolution as that of the SR image.

The SR image buffer 204 stores an SR image which is a super-resolution image generated by super-resolution processing executed most recently. When the process has just started and no frame of the SR image has been generated, the low-resolution image LR0, for example, is upsampled to an image having the same resolution as that of the SR image, and the acquired image is stored in the SR image buffer 204.

Similarly, super-resolution processing executing section 201b generates a difference image representing a difference between the low-resolution image LR1 of the next frame and the super-resolution image stored in the SR image buffer 204 and outputs a feedback value representing the generated different image to the summing section 202.

Super-resolution processing executing section 201c generates a difference image representing a difference between the low-resolution image LR2 and the super-resolution image stored in the SR image buffer 204 and outputs a feedback value representing the generated different image to the summing section 202.

The summing section 202 averages feedback values supplied from super-resolution processing executing sections 201a to 201c and outputs an image of the same resolution as that of the SR image obtained by the averaging to the adding section 203. The adding section 203 adds the SR image stored in the SR image buffer 204 and the SR image supplied from the summing section 202 and outputs an acquired SR image. Output of the adding section 203 is supplied to the outside of the image processing device as a result of super-resolution processing and is also supplied to and stored in the SR image buffer 204.

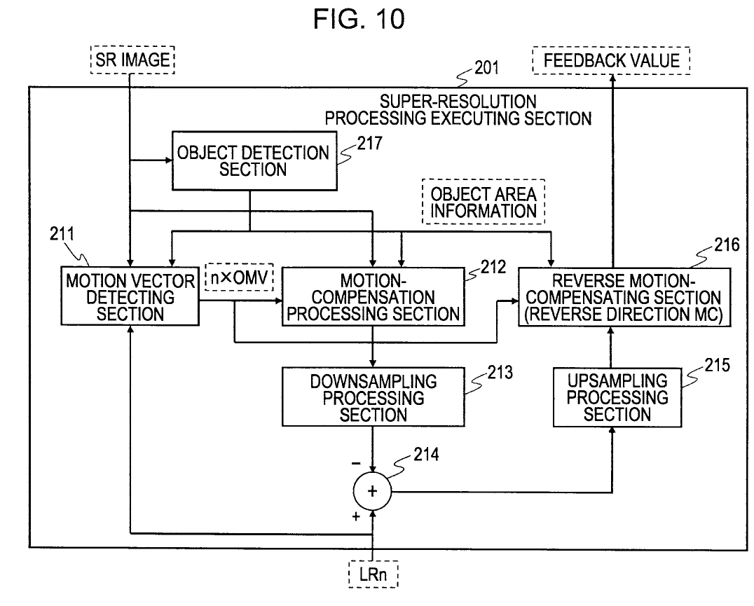

Next, configurations of super-resolution processing executing sections 201a to 201c illustrated in FIG. 9 will be described in detail with reference to FIG. 10. As illustrated in FIG. 10, super-resolution processing executing section 201 includes a motion vector detecting section 211, a motion-compensation processing section 212, a downsampling processing section 213, an adding section 214, an upsampling processing section 215, a reverse motion compensating section 216 and an object detection section 217.

A super-resolution image read from the SR image buffer 204 illustrated in FIG. 9 is input into the motion vector detecting section 211, the motion-compensation processing section 212 and the object detection section 217. A low-resolution image LRn which is, for example, photographed is input into the motion vector detecting section 211 and the adding section 214.

The object detection section 217 detects an object included in the SR image which is a super-resolution image read from the SR image buffer 204. The object detection section 217 generates object area information in which an object identification label is set to each object detected from the image. The object area information is supplied to the motion vector detecting section 211, the motion-compensation processing section 212 and the reverse motion compensating section 216.

The motion vector detecting section 211 of the image processing device of the embodiment of the invention calculates, on the object basis, an object motion vector (OMV) detected by the object detection section 217.

The motion vector detecting section 211 calculates, on an object basis, a motion vector (MV) on the basis of the SR image in accordance with an SR image which is an input super-resolution image and LRn which is a low-resolution image. For example, if there are n objects detected in object detection section 217, object-based motion vector (OMV) corresponding to n objects of each is calculated. n object-based motion vectors (OMV) are supplied to the motion-compensation processing section 212 and the reverse motion compensating section 216.

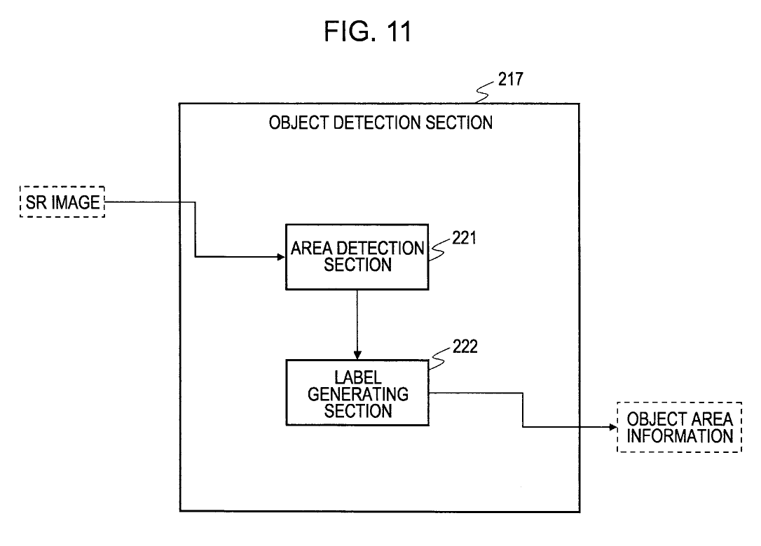

A detailed configuration of the object detection section 217 is illustrated in FIG. 11. The object detection section 217 includes an area detection section 221 and a label generating section 222 as illustrated in FIG. 11. The area detection section 221 detects an area of an object included in the super-resolution image read from the SR image buffer 204. The label generating section 222 sets up an identification label of the object detected by the area detection section 221 for each object.

The object area information output from the object detection section 217 includes object identification label set up to correspond to each pixel which constitutes the SR image which is the super-resolution image. That is, the object area information includes label information corresponding to a pixel representing that pixels constituting the SR image belong to which object.

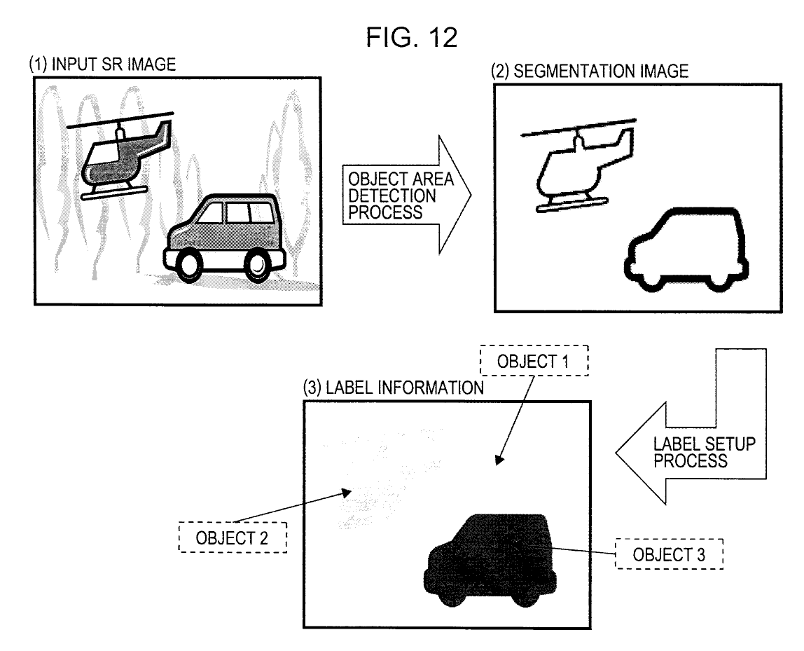

A process example of the object detection section 217 will be described with reference to FIG. 12. FIG. 12 illustrates (1) SR image input into the object detection section 217, (2) segmentation image generated during the object detection process in the area detection section 221, and (3) label information illustrating a label setup process with respect to each object in the label generating section 222.

The area detection section 221 detects object boundaries in an image by, for example, a general segmentation process so as to detect an object included in image. Various techniques have been proposed as the object detection process using segmentation, and thus the area detection section 221 can execute object detection by applying a related art technique.

Examples of the reference which discloses the segmentation technique using a level set method include “A Review of Statistical Approaches to Level Set Segmentation: Integrating Color, Texture, and Motion and Shape International Journal of Computer Vision 72 (2), pages 195-215, 2007, DANIEL CREMERS, MIKAEL ROUSSON, and RACHID DERICHE.” The area detection section 221 can execute the object detection by using, for example, the disclosed level set method.

(2) segmentation image is obtained by the segmentation process with respect to (1) SR image illustrated in FIG. 12. The segmentation image has data for determining boundaries of each object. In the illustrated example, a “helicopter” and an “automobile” are detected as objects. In the process of the embodiment of the invention, a background area is also determined as an object.

The label generating section 222 performs labeling for each object on the basis of the segmentation image. In the example illustrated in FIG. 12, identification labels for the “helicopter,” “automobile,” and “background” are set up. In the following exemplary description, the background is labeled as an object 1, the helicopter is labeled as an object 2 and the automobile is labeled as an object 3. The labels are set up on the pixel basis. With the label information, each pixel in the screen can be identified to belong to which object.

The object area information generated by the object detection section 217 includes information regarding to which object a pixel constituting the SR image from which an object is to be detected belongs. In the example illustrated in FIG. 12, each of the pixels which constitute the SR image is the information representing that to which object of the objects 1 to 3 the pixel corresponds.

The motion vector detecting section 211 illustrated in FIG. 10 calculates, on an object basis, a motion vector (MV) on the basis of the SR image in accordance with an SR image which is an input super-resolution image and LRn which is a low-resolution image. For example, if there are n objects detected in object detection section 217, object-based motion vector (OMV) corresponding to n objects of each is calculated. N object-based motion vectors (OMV) are supplied to the motion-compensated processing section 212 and the reverse motion compensating section 216.

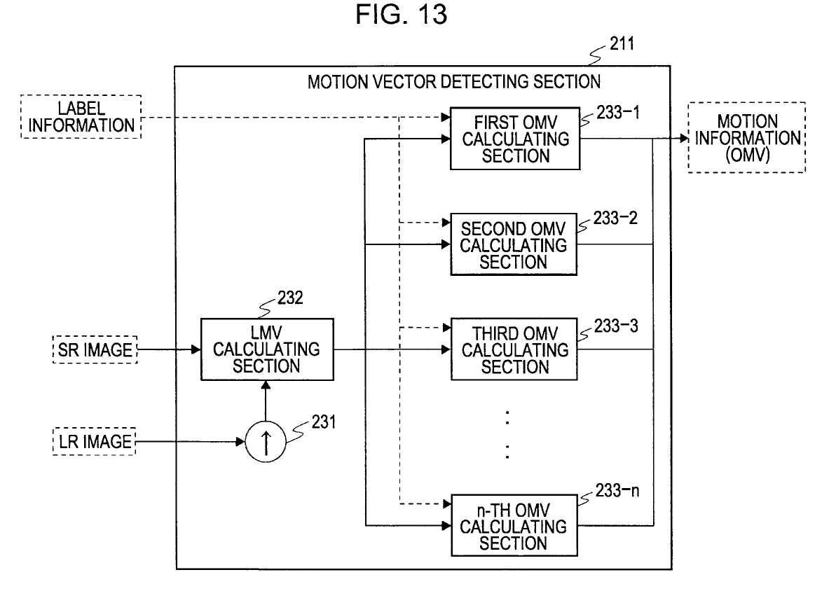

A detailed configuration of the motion detection section 211 is illustrated in FIG. 13. The motion vector detecting section 211 includes an upsampling processing section 231, a local motion vector (LMV) calculating section 232 and an object motion vector (OMV) calculating section 233. The object motion vector (OMV) calculating section 233 is configured by plural object motion vector (OMV) calculating sections 233 each obtaining an object motion vector (OMV) which is the motion vector corresponding to the object detected by the object detection section 217.

The motion vector detecting section 211 inputs the super-resolution image read from the SR image buffer 204 and the LR image which is the low-resolution image. The LR image is subjected to a resolution conversion in the upsampling processing section 231 to obtain the same resolution as that of the SR image. This resolution-converted image is input into the local motion vector (LMV) calculating section 232.

The local motion vector (LMV) calculating section 232 performs a local motion vector (LMV) calculation process between the SR image and the upsampled LR image. That is, a motion vector is obtained for each block, i.e., a small area obtained by dividing the image.

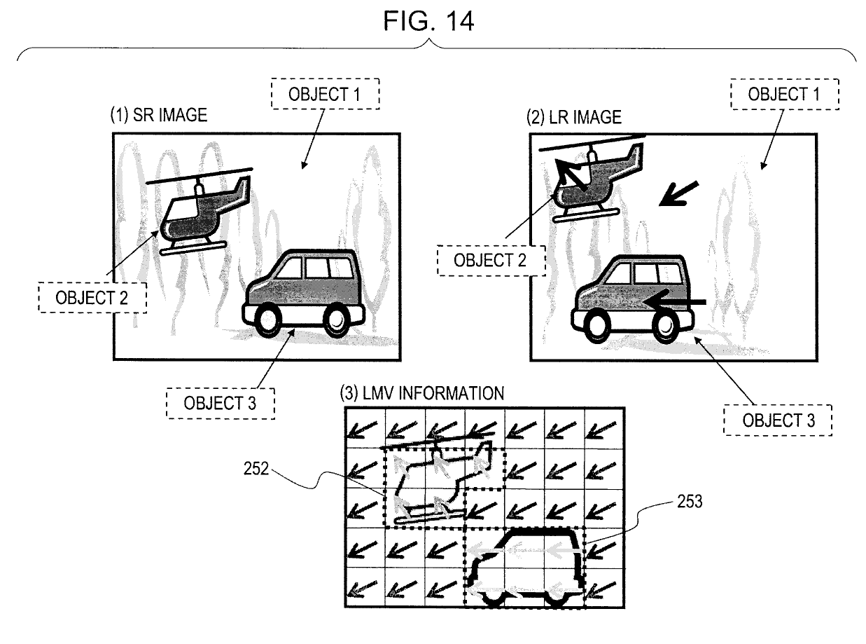

An exemplary calculation process of the local motion vector (LMV) executed by the local motion vector (LMV) calculating section 232 will be described with reference to FIG. 14. The local motion vector (LMV) calculating section 232 calculates a motion vector on a small area (block) basis on the screen by the similar block matching of the related art method.

FIG. 14 illustrates (1) SR image, (2) LR image and (3) local motion vector (LMV) information. The local motion vector (LMV) calculating section 232 calculates a motion vector on the small area (block) basis on the screen using (1) SR image and (2) LR image.

(1) SR image and (2) LR image have different photographing timings. In the example illustrated in the drawing, (2) LR image corresponds to a photographed image at a timing after the SR image. The object 1 (background), the object 2 (helicopter) and the object 3 (automobile) have respective inherent motions. Vectors representing these motions are the three arrows illustrated in (2) LR image in the drawing.

The Local motion vector (LMV) calculating section 232 performs a block matching on a small area basis in the screen (i.e., block) with the SR image as a reference image and calculates a motion vector (LMV), i.e., a local motion vector, on the small area (i.e., block) basis on the screen. A vector representing a moved position of each block of the SR image in a newly input LR image is generated by, for example, a block matching of an SR image generated on the basis of an image photographed in the past and a newly input LR image.

The result is the FIG. 14(3) local motion vector (LMV) information. In the example illustrated in FIG. 14, a local motion vector (LMV) corresponding to a total of 35 blocks, i.e., seven in a horizontal direction and five in a vertical direction, is calculated. In the illustrated example, the local motion vector (LMV) of the block group 252 in which the object 2 (helicopter) is included is the vector corresponding to the motion of the object 2 (helicopter). The Local motion vector (LMV) of the block group 253 in which the object 3 (automobile) is included is the vector corresponding to the motion of the object 3 (automobile). Other blocks are the vectors corresponding to the motion of object 1 (background).

The motion vectors may be of any configuration. For example, 2-parameter vectors representing parallel movement or 6-parameter vectors representing affine transformation that includes information regarding, for example, rotation.

The block-based plural local motion vectors (LMV) calculated by the local motion vector (LMV) calculating section 232 are input into the plural object motion vector (OMV) calculating section 233 illustrated in FIG. 13.

Each of the first to n-the object motion vector (OMV) calculating sections 233-1 to 233-n individually calculate an object motion vector (OMV) which is a motion vector corresponding to the object detected by the object detection section 217.

Each of the first to the n-the object-based motion vector (OMV) refinement sections 233-1 to 233-n inputs each object-based motion vector (OMV), the label information which is the object-based identification information generated by the object detection section 217 and the block-based local motion vector (LMV) calculated by the local motion vector (LMV) calculating section 232 and individually calculates the object motion vector (OMV) which is the object-based motion vector.

For example, a first OMV calculating section 233-1 illustrated in FIG. 13 calculates an object motion vector (OMV) corresponding to the object 1 (background) to which a label 1 is set. A second OMV calculating section 233-2 calculates an object motion vector (OMV) corresponding to the object 2 (helicopter) to which a label 2 is set. A third OMV calculating section 233-3 calculates an object motion vector (OMV) corresponding to the object 3 (automobile) to which a label 3 is set.

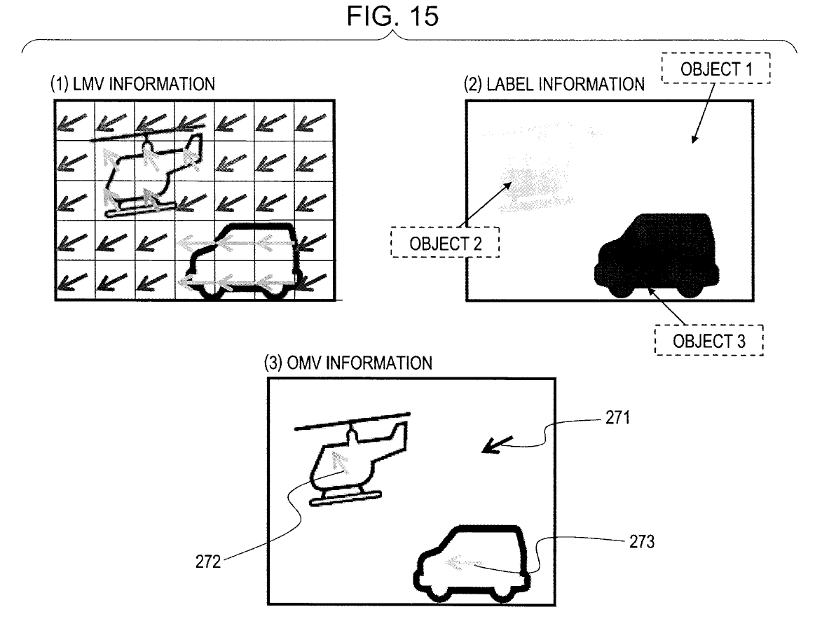

An exemplary calculation process of the object motion vector (OMV) executed by the object motion vector (OMV) calculating section 233 will be described with reference to FIG. 15. FIG. 15 illustrates (1) local motion vector (LMV) information, (2) Label information and (3) object motion vector (OMV) information.

In the object motion vector (OMV) calculating section 233, (3) object motion vector (OMV) is calculated using (1) local motion vector (LMV) information and (2) label information which is an identifier of each object.

A corresponding object is allocated to each of the object motion vector (OMV) calculating sections 233-1 to 233-n. That is, each of the object motion vector (OMV) calculating sections 233-1 to 233-n calculates an object motion vector (OMV) corresponding to the object area where its corresponding label is set up.

Each of the object motion vector (OMV) calculating sections 233-1 to 233-n calculates the object motion vector (OMV) by only applying local motion vector (LMV) information regarding the object area at which the corresponding label is set up.

In particular, the second OMV calculating section 233-2, for example, calculates the object motion vector (OMV) corresponding to the object 2 (helicopter) to which the label 2 is set. In this process, the local motion vector (LMV) of the block group 252 to which the label 2 in the LMV information in FIG. 14(3) is applied to, for example, calculate one object motion vector (OMV) by a calculation process of, for example, the average value. The object motion vector (OMV) is set to the object 2-based OMV 272 illustrated in FIG. 15(3).

The third OMV calculating section 233-3 calculates the object motion vector (OMV) corresponding to the object 3 (automobile) to which the label 3 is set. In this process, the local motion vector (LMV) of the block group 253 to which the label 3 in the LMV information in FIG. 14(3) is applied to, for example, calculate one object motion vector (OMV) by a calculation process of, for example, the average value. The object motion vector (OMV) is set to object 3-based OMV 273 illustrated in FIG. 15(3).

In addition, the first OMV calculating section 233-1, for example, calculates the object motion vector (OMV) corresponding to the object 1 (background) to which the label 1 is set. In this process, the local motion vector (LMV) of the block group to which the label 1 in the LMV information in FIG. 14(3) is applied to, for example, calculate one object motion vector (OMV) by a calculation process of, for example, the average value. The object motion vector (OMV) is set to the object 1-based OMV 271 illustrated in FIG. 15(3).

In the object motion vector (OMV) calculating sections 233-1 to 233-n, the object motion vector (OMV) corresponding to each of the objects detected by the object detection section 217 calculated by the process described above.

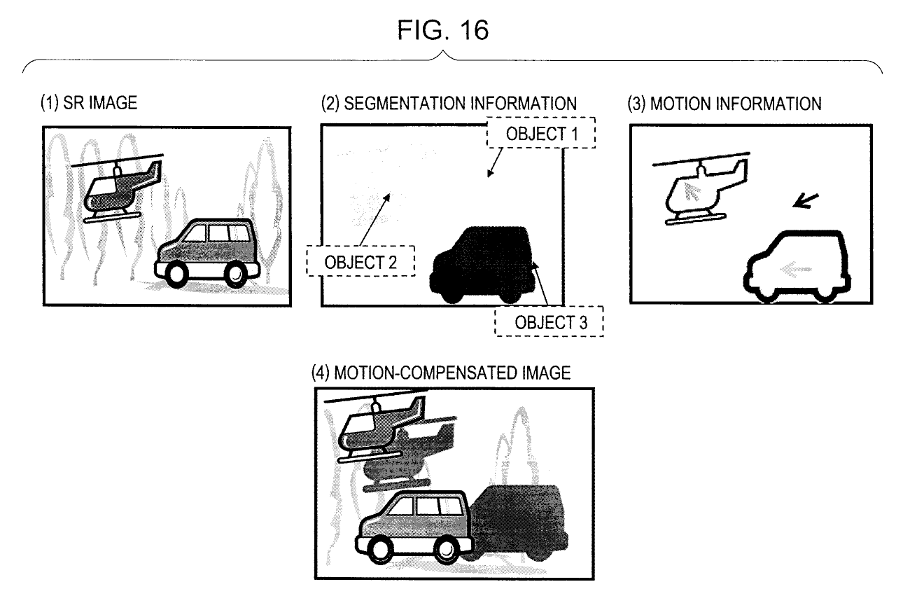

Next, a process executed by the motion-compensation processing section 212 of super-resolution processing executing section 201 illustrated in FIG. 10 will be described with reference to FIG. 16.

The motion-compensation processing section 212 inputs (1) a super-resolution image read from the SR image buffer 204, (2) object area information supplied from the object detection section 217, and (3) an object motion vector (OMV) which is an object-based motion vector supplied from the motion vector detecting section 211. The object area information supplied from the object detection section 217 includes label information representing to which object each pixel which constitutes the SR image belongs.

The motion-compensation processing section 212 performs motion compensation to the super-resolution image on the basis of the input information and generates (4) a motion-compensated (MC) image. The motion-compensation processing section 212 outputs the generated motion-compensated image (MC image) to the downsampling processing section 213.

A motion-compensation process executed by the motion-compensation processing section 212 will be described with reference to FIG. 16. An upper part of FIG. 16 illustrates (1) super-resolution image read from the SR image buffer 204, (2) object area information supplied from the object detection section 217 and (3) an object motion vector (OMV) which is the object-based motion vector supplied from the motion vector detecting section 211. In the lower part of FIG. 16 illustrates generated information regarding (4) motion-compensated image generated by the input information and the motion-compensation process executed by the motion-compensation processing sections 212.

The motion-compensation processing section 212 moves the pixel position of (1) SR image in accordance with (2) object area information (label information) and (3) object motion vector (OMV), performs a process to generate a corrected SR image with a position corresponding to the newly input LR image and generates (4) motion-compensated image. That is, the pixel position of the SR image is moved to generate a motion-compensated image (MC image) in which the position of the object in the SR image being aligned with the position of the object in the LR. The motion-compensated image is also called the MC image.

A procedure of generating a motion-compensated image executed in the motion-compensation processing section 212 is as follows.
(Step 1) virtually generate an LR image using the SR image, the segmentation information and the motion information.
(Step 2) move and synthesize pixels of each object of the SR image in accordance with motion information.
(Step 3) interpolate emptied portions from which the pixels are removed with neighboring similar pixels.

With these processes, (4) motion-compensated image illustrated in FIG. 16 is generated which is a corrected SR image having a position corresponding to the newly input LR image.

The downsampling processing section 213 of super-resolution processing executing section 201 illustrated in FIG. 10 generates an image of the same resolution as that of the LRn by downsampling the image supplied from the motion-compensation processing section 212 and outputs the generated image to the adding section 214. Obtaining a motion vector from the SR image and the LRn and acquiring an image motion-compensated by the obtained motion vector to be an image of the same resolution of that of the LR image corresponds to simulating a photographed image on the basis of the SR image stored in the SR image buffer 204.

The adding section 214 generates a difference image which represents a difference between the LRn and a thus-simulated image and outputs the generated difference image to the upsampling processing section 215.

The upsampling processing section 215 generates an image of the same resolution as that of the SR image by upsampling the difference image supplied from the adding section 214 and outputs the generated image to the reverse motion compensating section 216.

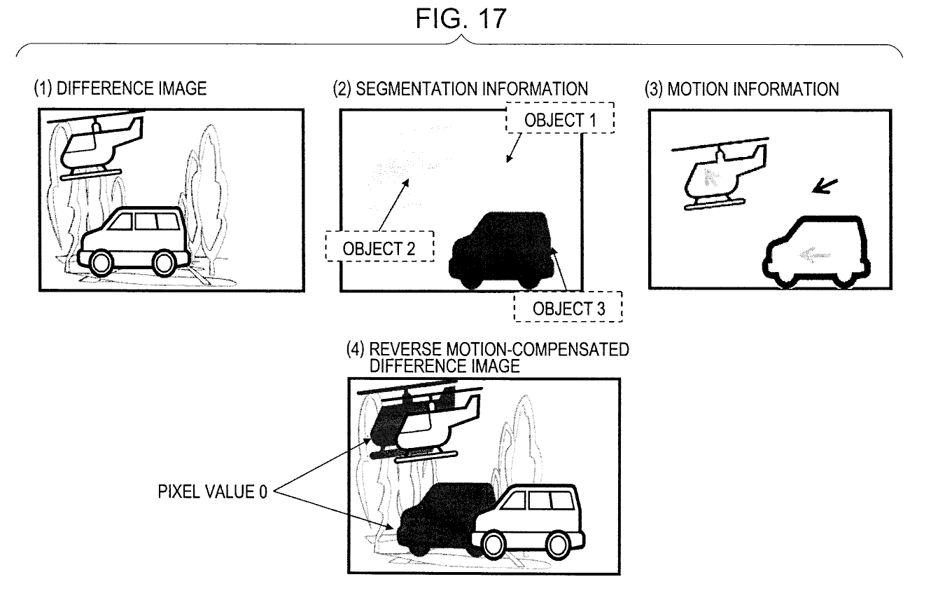

Processes executed by the reverse motion compensating section 216 will be described with reference to FIG. 17. The reverse motion compensating section 216 inputs (1) a difference image input from the upsampling processing section 215, (2) object area information supplied from the object detection section 217 and (3) an object motion vector (OMV) which is the object-based motion vector supplied from the motion vector detecting section 211. The object area information supplied from the object detection section 217 includes label information representing to which object each pixel which constitutes the SR image belongs.

The reverse motion compensating section 216 inputs (2) object area information supplied from the object detection section 217 and (3) object motion vector (OMV) which is the object-based motion vector supplied from the motion vector detecting section 211. The reverse motion compensating section 216 performs, on the basis of the input information, the reverse direction motion compensation to the difference image input from (1) upsampling processing section 215 and generates (4) difference image acquired by the reverse direction motion compensation illustrated in FIG. 17.

In particular, the reverse motion compensating section 216 includes the following steps:
(Step 1) move a position of the object of the difference image (FIG. 17(1)) of the LR image and the motion-compensated image to a time of the SR image; and
(Step 2) insert a pixel value of 0 in an occlusion area produced by the movement of the object.

With these processes, (4) a different image obtained by reverse direction motion compensation illustrated in FIG. 17 is generated which is a corrected SR image having a position corresponding to the newly input LR image.

The reverse motion compensating section 216 generates a feedback value showing (4) difference image acquired by the reverse direction motion compensation illustrated in FIG. 17 and outputs the feedback value to the summing section 202 of super-resolution processing section 200 illustrated in FIG. 9. The feedback value is a value representing a difference image having the same resolution as that of the SR image. A position of an object in an image obtained by reverse direction motion compensation is near a position of an object in the SR image stored in the SR image buffer 204.

The summing section 202 of super-resolution processing section illustrated in FIG. 9 averages feedback values supplied from super-resolution processing executing sections 201a to 201c and outputs an image of the same resolution as that of the SR image obtained by the averaging to the adding section 203. The adding section 203 adds the SR image stored in the SR image buffer 204 and the SR image supplied from the summing section 202 and outputs an acquired SR image. Output of the adding section 203 is supplied to the outside of the image processing device as a result of super-resolution processing and is also supplied to and stored in the SR image buffer 204.

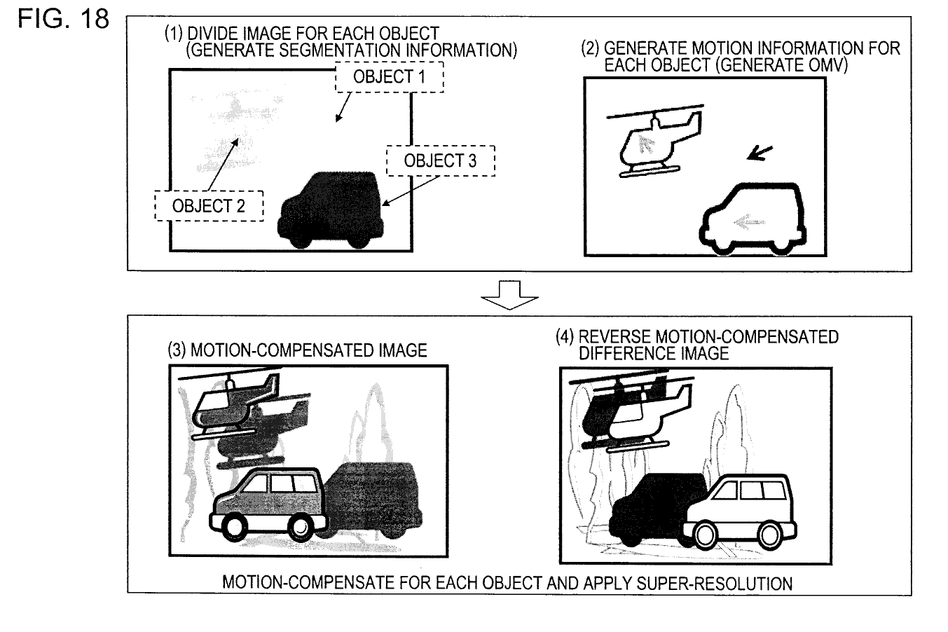

In this manner, super-resolution processing in accordance with an embodiment of the invention is executed. A characteristic of super-resolution processing in accordance with an embodiment of the invention is, as illustrated in FIG. 18, the object detection section 217 identifies an object included in an image and generates object area information illustrated in FIG. 18(1) and the motion vector detecting section 211 generates the object motion vector (OMV) which is the object-based motion vector. The information is then applied to super-resolution processing. (3) motion-compensated image and (4) reverse motion-compensated difference image are generated illustrated in FIG. 18 generated in super-resolution processing are generated with the application of the object area information and the object motion vector (OMV) which is the object-based motion vector.

Since the motion vector is generated on the object basis in the process of the embodiment of the invention, a larger area can be used for calculating of one object-based motion vector (OMV) as compared with the process using a block-based local motion vector (LMV). Accordingly, detection accuracy of the motion vector increases.

In a process in which a global motion vector (GMV) corresponding to one screen corresponding to a camera motion is used, individual motion of each object is not able to be reflected and thus super-resolution processing corresponding to the motion of each object is not able to be made. However, in the process of the embodiment of the invention, super-resolution processing reflecting the motion of each object is possible and thus a highly precise super-resolution process reflecting the motion of each object can be provided.

### (3) Embodiment with Object-Based Motion Vector (OMV) Refinement Section (Second Embodiment)

Next, an embodiment which has a modified configuration of the motion vector detecting section 211 in super-resolution processing executing section 201 illustrated in FIG. 10 as a second embodiment will be described.

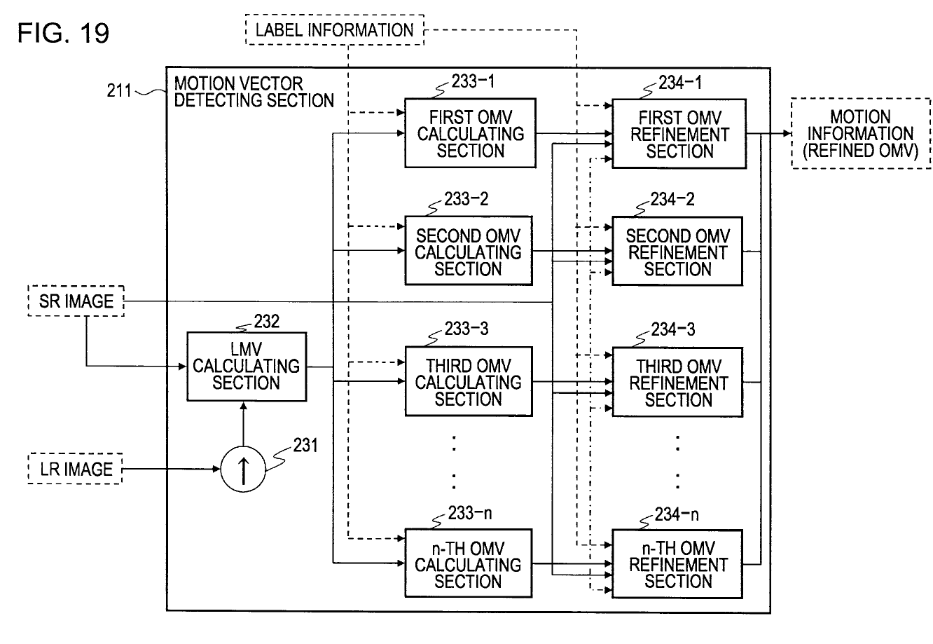

A configuration of the motion vector detecting section 211 according to the present embodiment is illustrated in FIG. 19. The motion vector detecting section 211 according to the present embodiment is similar to the motion vector detecting section 211 described with reference to FIG. 13 in the foregoing embodiment except for including an object-based motion vector (OMV) refinement sections 234-1 to 234n.

Each of the object-based motion vector (OMV) refinement sections 234-1 to 234n inputs each object-based motion vector (OMV) from the preceding object-based motion vector (OMV) generating sections 233-1 to 233-n and performs a refinement process of the input vector.

Each of the object-based motion vectors (OMV) refinement sections 234-1 to 234-n inputs the SR image, the upsampled LR image and label information which is object area information generated by the object detection section 217. Refinement of the object-based motion vector (OMV) generated by the object-based motion vector (OMV) generating sections 233-1 to 233-n is executed using the input information. The label information is used as an object identifier identifying an object to which a configuration pixel of the SR image belongs.

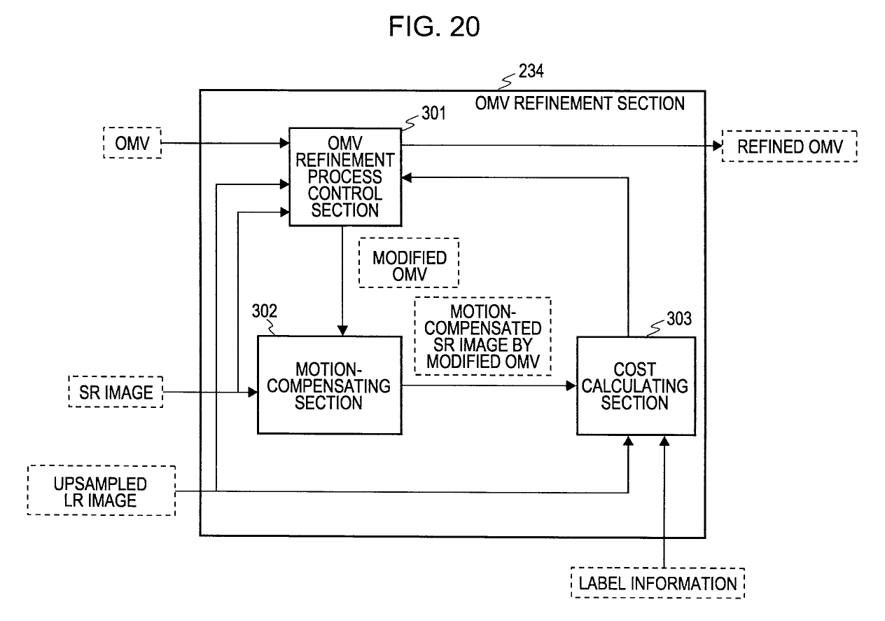

A configuration of the object-based motion vector (OMV) refinement section 234 and processes to be executed will be described in detail with reference to FIG. 20. FIG. 20 illustrates the configuration of the object-based motion vector (OMV) refinement section 234 in detail.

The object-based motion vector (OMV) refinement section 234 includes an object-based motion vector (OMV) refinement process control section 301, a motion-compensation processing section 302 and a cost calculation section 303 as illustrated in FIG. 20.

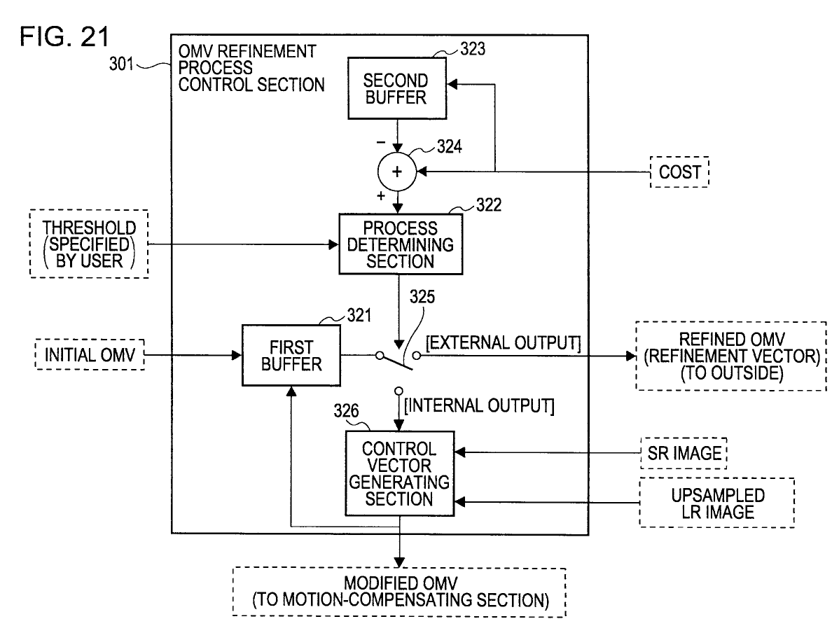

The object-based motion vector (OMV) refinement process control section 301 generates the modified OMV by updating parameters of the object-based motion vector (OMV) input from the preceding object-based motion vector (OMV) generating section 233 and the object-based motion vector (OMV) by applying the SR image and the upsampled LR image. The generated modified OMV is input into the motion-compensation processing section 302. The process of generating the modified OMV will be described in detail with reference to FIG. 21.

The motion-compensation processing section 302 generates a motion-compensated image by the motion-compensation process on the basis of the modified OMV input from the object-based motion vector (OMV) refinement process control section 301. The motion-compensated image is performed by the same process as described with reference to FIG. 16.

A cost calculation section 303 performs cost calculation corresponding to difference between the upsampled LR image and the motion-compensated image generated by the motion-compensation processing section 302 by applying the modified OMV. In the cost calculation, the pixel value of a specified object area corresponding to the OMV to be processed included in the motion-compensated image and the upsampled LR image is acquired. The smallest square difference (SSD) or the normalized correlation (NCC) of the pixel value in the object is calculated in accordance with the following equations, (Equation 2) and (Equation 3).

$$\begin{matrix}SSD ( G , P ) = {\sum }_{m} {\sum }_{n} {( {p}_{mn} - {g}_{mn} )}^{2} & Equation 2 \\ NCC ( G , P ) = \frac{A}{B \cdot C} * ( - 1 ) \\ A = ( N \sum \sum {g}_{mn} {p}_{mn} - ( \sum \sum {g}_{mn} ) \cdot ( \sum \sum {p}_{mn} ) ) \\ B = {( N \sum \sum {g}_{mn}^{2} - {( \sum \sum {g}_{mn} )}^{2} )}^{- 1 / 2} \\ C = {( N \sum \sum {p}_{mn}^{2} - {( \sum \sum {p}_{mn} )}^{2} )}^{- 1 / 2} & Equation 3\end{matrix}$$

In Equations 2 and 3, G represents a motion-compensated image generated by the application of the modified OMV, gₘₙ represents a pixel value (mn is a pixel position coordinate system) of a configuration pixel of the image G, P represents an upsampled LR image, and pₘₙ represents a pixel value (mn is a pixel position coordinate system) of a configuration pixel of the image P. Normalized correlation (NCC) has an opposite polarity obtained by multiplying a normal NCC calculation equation by −1 from the viewpoint of being treated as a cost.

As a value of the smallest square difference (SSD) calculated in Equation 2 is small, the cost is also considered to be small. Similarly, a value of the normalized correlation (NCC) calculated in Equation 3 is small, the cost is also considered to be small.

A cost calculation section 303 outputs a calculated cost to the object-based motion vector (OMV) refinement process control section 301. In the object-based motion vector (OMV) refinement process control section 301, OMV parameters are changed until a predetermined number of processes are completed or a predetermined cost is input.

If the calculated cost reaches a value not greater than the predetermined threshold cost, or if the number of processes reaches the predetermined maximum loop count, the object-based motion vector (OMV) refinement process control section 301 outputs an object-based motion vector (OMV) with the minimum cost at the time as a refinement result. The OMV is output to the subsequent process as the refined OMV.

The refined OMV is output to the motion-compensation processing section 212 and the reverse motion compensating section 216 illustrated in FIG. 10. Processes using the refined OMV are performed in the motion-compensation processing section 212 and the reverse motion compensating section 216.

For example, the motion-compensation processing section 212 generates (4) a motion-compensated image by applying an object-based refined OMV as motion information of FIG. 16(3) in the process described above with reference to FIG. 16. The reverse motion compensating section 216 generates (4) reverse motion-compensated difference image by applying an object-based refined OMV as motion information of FIG. 17(3) in the process described above with reference to FIG. 17.

An OMV refinement section 234 illustrated in FIG. 19 generates a refined OMV as a vector obtained by making an object-based motion vector (OMV) calculated by the OMV calculating section 233 more close to a motion between images of each actual object. The motion-compensation processing section 212 and the reverse motion compensating section 216 can perform the process using a refined OMV more close to the motion of each object. Accordingly, super-resolution processing can be more precise and an image of higher quality can be obtained.

An object-based motion vector (OMV) refinement process control section 301 in an OMV refinement section 234 illustrated in FIG. 20 generates a modified OMV through parameter update of the object-based motion vector (OMV) and inputs the modified OMV into the motion-compensation processing section 302 by applying an object-based motion vector (OMV) input from the preceding object-based motion vector (OMV) generating section 233, the SR image, and the upsampled LR image as described above.

The parameter update process of the object-based motion vector (OMV) may include setting plural sets of predetermined applicable parameters and sequentially applying the parameter sets to generate a modified OMV. An exemplary modified OMV generation process by the parameter update executed by the object-based motion vector (OMV) refinement process control section 301 will be described with reference to FIG. 21.

The modified OMV generation process by the parameter update executed by the refinement process control section 301 will be described in an order of A. initialization process, B. initial (first time) process and C. processes for the second time and afterwards.

### A. Initialization Process

First, an initialization process will be described.

(A1) An object-based motion vector (OMV) calculated by the OMV calculating section 233 illustrated in FIG. 19 is stored in a first buffer 321 as an initial OMV.

(A2) Thresholds used for the process determination are specified from outside by the user or are given from outside as prescribed values.

(A3) Cost=0 is set to a second buffer 323.

(A4) A switch 325 is set for an internal output side (i.e., an output to a refined vector generating section 326).

### B. Initial (i.e., a First Time) Process

(B1) initial OMV stored in the first buffer 321 is input into a refined vector generating section 326. The refined vector generating section 326 modifies the parameter of the initial OMV and generates a modified OMV so as to be close to an object motion between the SR image and the upsampled LR image.

(B-2) modified OMV is stored in the first buffer 321 and also supplied to an external motion-compensation processing section 302 (see FIG. 20).

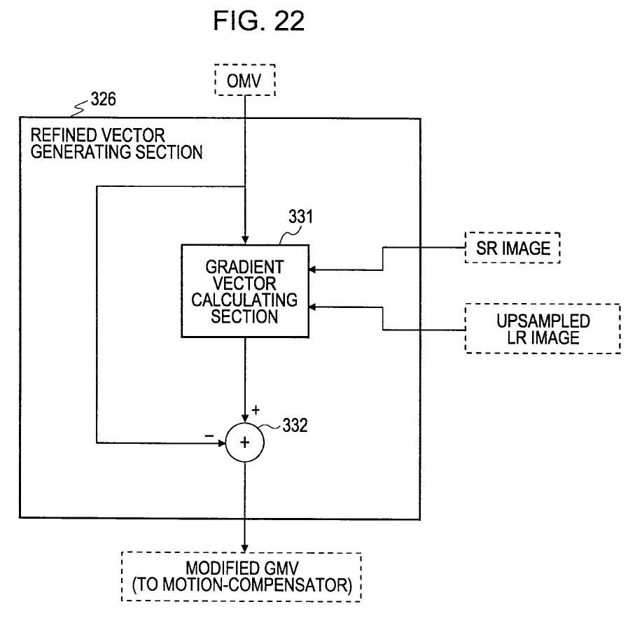

In the process of (B1), the refined vector generating section 326 modifies parameter of the initial OMV and generates a modified OMV so as to be close to an object motion between the SR image and the upsampled LR image. Exemplary configuration and process of the refined vector generating section 326 which performs the process will be described with reference to FIG. 22. The refined vector generating section 326 includes a gradient vector calculating section 331 and an adder 332 as illustrated in FIG. 22.

The gradient vector calculating section 331 calculates a gradient vector is by applying the SR image, the upsampled LR image and the input OMV information. Here, the pixel value g of the OMC image is defined as follows. The OMC image is a motion-compensated image (MC image) provided by an object-based motion vector (OMV). g(image,OMV,x,y)

Wherein, the image is a reference image of the omc, OMV is an object-based motion vector (OMV), and x, y is a position coordinates of a pixel in the GMC image (horizontal and vertical).

A 6-parameter affine transformation is employed as the object-based motion vector (OMV).

X′=a₀x+a₁y+a₂

Y′=a₃x+a₄y+a₅

S gradient vector of the OMV with respect to a predetermined cost function E is obtained in the gradient vector calculating section 331. The gradient vector is as follows.

n=0 . . . 5

Δaₙ=(δE/δaₙ)

For example, suppose that the sum of squares of the difference between the OMC image and the SR image is set to the cost function as shown in the following Equation (Equation 4). pmn is a pixel value of a pixel (m, n) on the SR image.

$$SSD ( G , P ) = {\sum }_{m} {\sum }_{n} {( {p}_{mn} - {g}_{mn} )}^{2} \\ {g}_{m , n} = g ( UpsampledLR , GMV , x , y ) \qquad Equation 4$$

The gradient vector is represented by the following Equation (Equation 5).

$$Δ {a}_{n} = {\sum }_{m} {\sum }_{n} 2 ( \begin{matrix}{p}_{m , n} - g \\ ( image , GMV , m , n )\end{matrix} ) \cdot \frac{\partial g ( image , GMV , m , n )}{\partial {a}_{n}} \qquad Equation 5$$

The adder 332 subtracts the gradient vector from the original vector.

aₙ=aₙ−Δaₙ

The an is considered as a parameter of the object-based motion vector (OMV) after the modification. The cost function may be, for example, the NCC or a difference absolute value sum in accordance with the application.

In the process of (B1), the initial OMV is modified by the processing constitution illustrated in FIG. 22 so as to be close to an object motion between the SR image and the upsampled LR image and a modified OMV is generated in the refined vector generating section 326. Then, as a process (B-2), the modified OMV is stored in the first buffer 321 and then supplied to an external motion-compensation processing section 302 (see FIG. 20).

### C. Processes for the Second Time and Afterwards

Now, referring again to FIG. 21, C. processes for the second time and afterwards in the modified OMV generation process through parameter updating executed by the refinement process control section 301 executes will be described.

(C1) object-based motion vector (OMV) refinement process control section 301 receives the cost generated by a cost calculation section 303 (see FIG. 20) and calculates difference between the received cost and the cost stored in a second buffer 323 of a differential device 324.

(C2) input cost is stored in the second buffer 323 after the difference value calculation.

(C3) process determining section 322 makes a process determination on the basis of the input difference value and the threshold.

(C3-1) If the difference value of the cost is not greater than the threshold, the process determining section 322 outputs, to the outside, the OMV stored in the first buffer 321 as a refined OMV.

(C3-2) If the difference value is not less than the threshold, the OMV stored in the first buffer 321 is input into the refined vector generating section 326 and the object-based motion vector (OMV) to be verified at the next time is generated.

The processes for the second time and afterwards are performed repeatedly. That is, if the calculated cost reaches a value not greater than the predetermined threshold cost, or if the number of processes reaches the predetermined maximum loop count, the object-based motion vector (OMV) refinement process control section 301 outputs an object-based motion vector (OMV) with the minimum cost at the time as a refinement result. That is, the OMV is output to the subsequent step as a refined OMV.

In the present embodiment, a refined OMV is generated by causing the object-based motion vector (OMV) calculated by the OMV calculating section 233 to be more close to a motion between the images of each actual object in the OMV refinement section 234 illustrated in FIG. 19. The motion-compensation processing section 212 and the reverse motion compensating section 216 can perform a process using the refined OMV, i.e., the refined OMV close to the motion of each object. As a result, a high quality super-resolution image with increased precision in super-resolution processing can be generated.

### (4) Embodiment in which User can Specify area to be Super-Resolved (Third Embodiment)

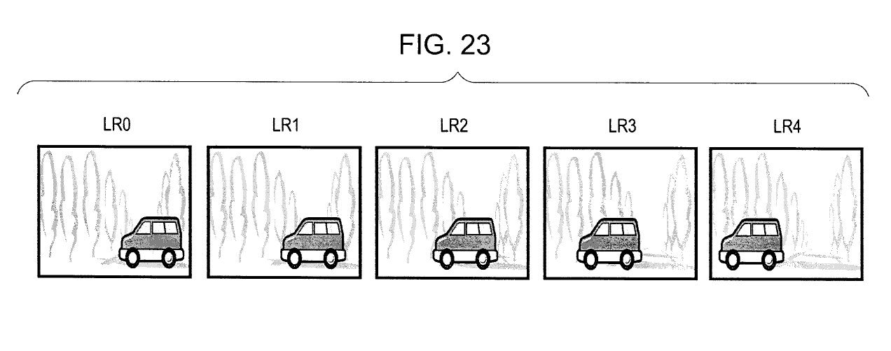

Next, an embodiment in which a user can specify an area to be super-resolved, e.g., an object to be processed, will be described. For example, only one object (automobile) included in low-resolution images LR0 to LR4 which are configured by continuous frame images illustrated in FIG. 23 is set as an object for super-resolution processing. That is, the user specifies the automobile as the object for super-resolution processing. The image processing device performs a process with only the automobile area as super-resolution processing object in accordance with the user specification. The image processing device of the present embodiment can perform a process not for the entire image but only for an area that includes a specified object as super-resolution processing area.

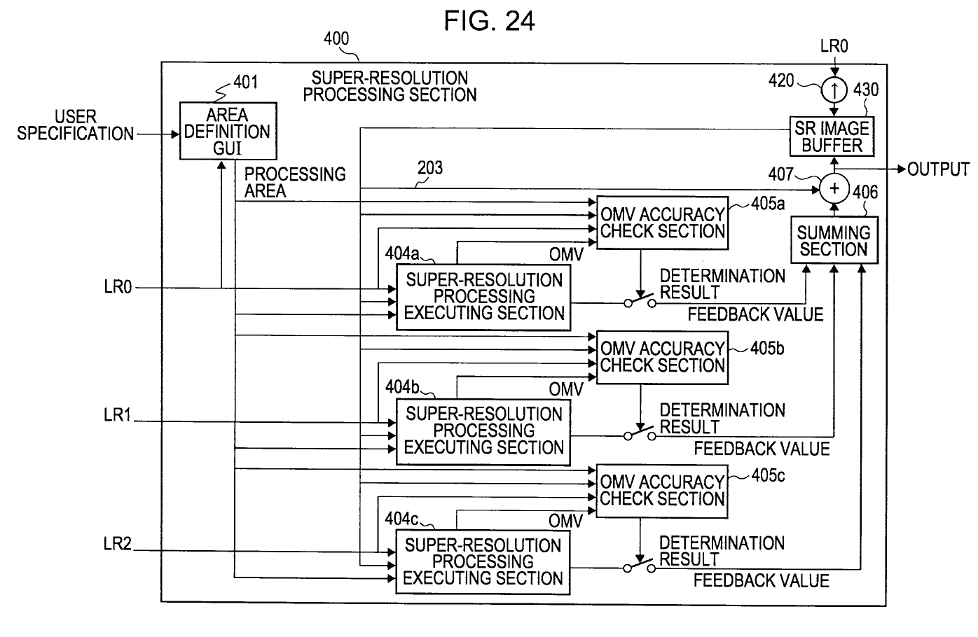

The configuration of the image processing device according to the present embodiment has a similar configuration to those illustrated in FIGS. 7 and 8 described in the foregoing embodiments. However, a configuration of super-resolution processing section differs from that illustrated in FIG. 9. An exemplary configuration of super-resolution processing section according to the present embodiment will be described with reference to FIG. 24.

Super-resolution processing section 400 illustrated in FIG. 24 corresponds, for example, to super-resolution processing section 106 of the image processing device 100 illustrated in FIG. 7 and to super-resolution processing section 123 of the image processing device 110 illustrated in FIG. 8. As illustrated in FIG. 24, super-resolution processing section 400 includes an area definition GUI 401, an upsampling processing section 402, an SR image buffer 403, super-resolution processing executing sections 404a to 404c, OMV precision check sections 405a to 405c, a summing section 406 and an adding section 407.

For example, the LR0, which is the photographed low-resolution LR image, is upsampled in the upsampling processing section 402 and it is stored in the SR image buffer 403 as the initial value of the SR image.

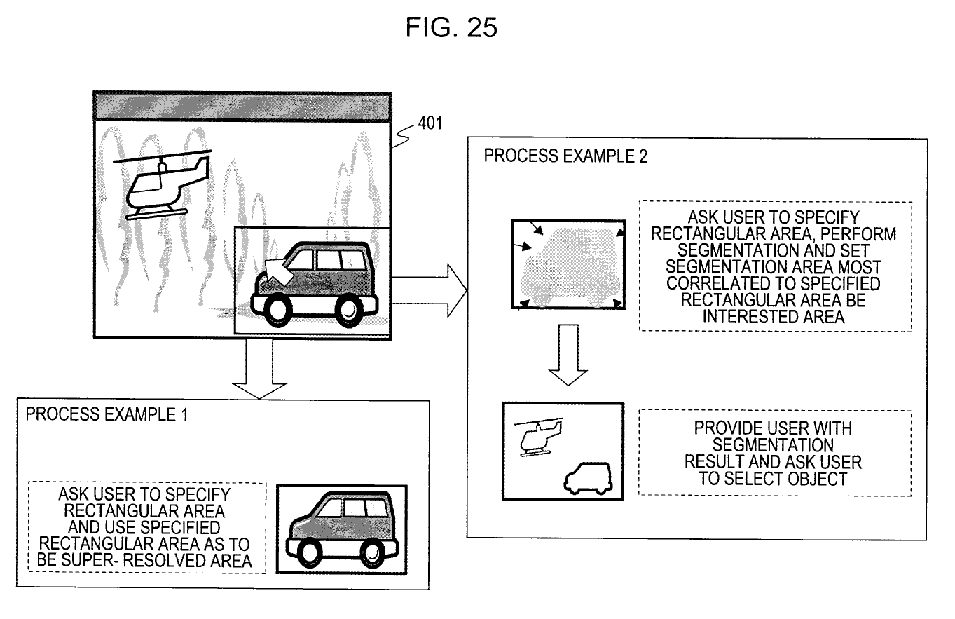

The area definition GUI 401 is a graphical user interface on which an LR0 image is displayed to be presented to a user who specifies an area to be subjected to super-resolution processing. An examples of the specification process of the area to be super-resolved by the area definition GUI 401 will be described with reference to FIG. 25.

Two specification process examples of the area to be super-resolved using the area definition GUI 401 are illustrated in FIG. 25. Both the process examples 1 and 2 have an automobile specified as an area to be super-resolved (object).

The process example 1 is a process in which a user is asked to specify an area (in the present embodiment, a rectangular area) which includes an object (i.e., an automobile) included in the LR0 image displayed on the display. The rectangular area itself is used as an area to be processed in super-resolution processing.

The process example 2 first performs segmentation while asking a user to specify an area (in the present embodiment, a rectangular area) which includes an object (i.e., an automobile) included in the LR0 image displayed on the display. Then, a segmentation result in which the area that is the most correlated with the rectangular area specified by the user is highlighted as an interest area is displayed. The user is then asked to select an object with respect to the displayed information and the selected object area is set to an area to be subjected to super-resolution processing.

For example, in this manner, the area to be super-resolved is specified using the area definition GUI 401.

The processing area information for the acquired super-resolution acquired by the user specification is sent to super-resolution processing executing sections 404a to 404c and the OMV precision check devices 405a to 405c illustrated in FIG. 24. In super-resolution processing executing sections 404a to 404c, the LR image, the SR image and super-resolution processing area information are input to calculate the feedback value and the OMV.

A low-resolution image LR0 which is, for example, a photographed low-resolution LR image, is input in super-resolution processing executing section 404a, and a low-resolution image LR1 is input in super-resolution processing executing section 404b. A low-resolution image LR2 is input in super-resolution processing executing section 404c. The LR0 to the LR2 are continuously photographed images, for example, and have overlapped portions in the photographed areas thereof. If the images are photographed continuously, the objects in the photographed images are usually slightly misaligned with one another due to, for example, blurring and thus are not completely aligned with each other and partly overlap one another. It suffices that the input images are not limited to continuously photographed images but may be images having partially overlapping portions.

Super-resolution processing executing section 404a generates a difference image representing a difference between the low-resolution image LR0 and the super-resolution image stored in the SR image buffer 403 and calculates a feedback value and the OMV. This process is executed only to the area specified by super-resolution processing area information. The object-based motion vector (OMV) corresponding to the area specified by super-resolution processing area information is input into the OMV precision check section 405a.

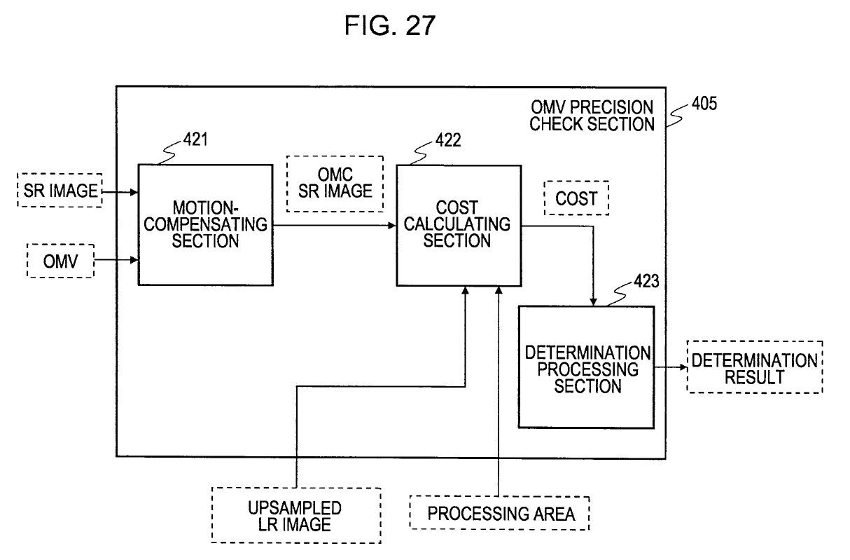

The OMV precision check section 405a verifies precision of the object-based motion vector (OMV) generated by super-resolution processing executing section 404a. The process will be described in detail later with reference to FIG. 27.

If it is determined that the precision of the object-based motion vector (OMV) generated by super-resolution processing executing section 404a is high as a verification result of the OMV precision check section 405a, the OMV precision check section 405a outputs a feedback value generated by super-resolution processing executing section 404a to the summing section 406. The feedback value is a value representing a difference image having the same resolution as that of the SR image.

Similarly, super-resolution processing executing section 404b generates a difference image representing differences between the low-resolution image LR1 of the next frame and the super-resolution image stored in the SR image buffer 403 and calculates a feedback value and the OMV. This process is executed only to the area specified by super-resolution processing area information. The object-based motion vector (OMV) corresponding to the area specified by super-resolution processing area information is input into the OMV precision check section 405b.

The OMV precision check section 405b verifies precision of the object-based motion vector (OMV) generated by super-resolution processing executing section 404b. If it is determined that the precision of the object-based motion vector (OMV) generated by super-resolution processing executing section 404b is high as a verification result, the OMV precision check section 405b outputs a feedback value generated by super-resolution processing executing section 404b to the summing section 406.

Similarly, super-resolution processing executing section 404c generates a difference image representing differences between the low-resolution image LR2 of the next frame and the super-resolution image stored in the SR image buffer 403 and calculates a feedback value and the OMV. This process is executed only to the area specified by super-resolution processing area information. The object-based motion vector (OMV) corresponding to the area specified by super-resolution processing area information is input into the OMV precision check section 405c.

The OMV precision check section 405c verifies precision of the object-based motion vector (OMV) generated by super-resolution processing executing section 404c. If it is determined that the precision of the object-based motion vector (OMV) generated by super-resolution processing executing section 404c is high as a verification result, the OMV precision check section 405c outputs a feedback value generated by super-resolution processing executing section 404c to the summing section 406.

The OMV precision check sections 405a to 405c input the OMV, the SR image, the LR image and super-resolution processing area information and verifies precision of the object-based motion vector (OMV) generated by super-resolution processing executing sections 404a to 404c. Switch is changed in accordance with precision verification result. If it is determined that precision of OMV is high, a switch operation is performed so that the feedback value can be transmitted to the summing section 406.

The summing section 406 averages feedback values supplied from super-resolution processing executing sections 404a to 404c and outputs an image of the same resolution as that of the SR image obtained by the averaging to the adding section 407. The adding section 407 adds the SR image stored in the SR image buffer 403 and the SR image supplied from the summing section 406 and outputs an acquired SR image. Output of the adding section 407 is supplied to the outside of the image processing device as a result of super-resolution processing and is also supplied to and stored in the SR image buffer 403.

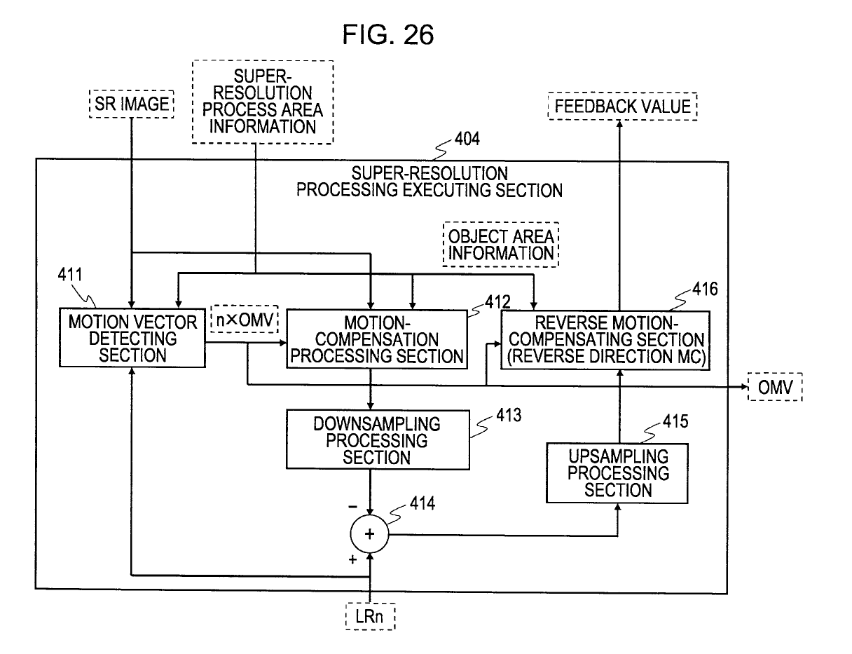

Next, configurations of super-resolution processing executing sections 404a to 404c illustrated in FIG. 24 will be described in detail with reference to FIG. 26. As illustrated in FIG. 26, super-resolution processing executing section 404 includes a motion vector detecting section 411, a motion-compensated processing section 412, a downsampling processing section 413, an adding section 414, an upsampling processing section 415 and a reverse motion compensating section 416.

A super-resolution image read from the SR image buffer 403 illustrated in FIG. 24 is input in the motion vector detecting section 411 and the motion-compensated processing section 412. A low-resolution image LRn which is, for example, photographed is input in the motion vector detecting section 411 and the adding section 414. Super-resolution processing area information specified by the user in the area definition GUI 401 is input into the motion vector detecting section 411, the motion-compensation processing section 412 and the reverse motion compensating section 416.

The motion vector detecting section 411 calculates, on super-resolution processing specification area basis, e.g., on an object basis, a motion vector (MV) on the basis of the SR image in accordance with an SR image which is an input super-resolution image and LRn which is a low-resolution image. For example, if n specified objects exist, an object-based motion vector (OMV) corresponding to each of the n objects is calculated. N object-based motion vectors (OMV) are supplied to the motion-compensated processing section 412 and the reverse motion compensating section 416. A detailed configuration of the motion vector detecting section 411 is the same as that described with reference to FIG. 13.

The motion-compensation processing section 412 performs the process described with reference to FIG. 16. That is, the motion-compensation processing section 412 inputs the information illustrated in FIG. 16, i.e., (1) super-resolution image read from the SR image buffer 404, (2) super-resolution process area information supplied from the area definition GUI 401 (i.e., object area information) and (3) an object motion vector (OMV) which is the object-based motion vector supplied from the motion vector detecting section 411, performs motion compensation to the super-resolution image and generates (4) motion-compensated (MC) image. The motion-compensation processing section 412 outputs the generated motion-compensated image (MC image) to the downsampling processing section 413.

The process example in which information regarding all the objects are illustrated in FIG. 16. In the present embodiment, however, the process is executed only to an area corresponding to super-resolution processing area information (for example, the object area information) supplied from the area definition GUI 401.

The downsampling processing section 413 of super-resolution processing executing section 404 illustrated in FIG. 26 generates an image of the same resolution as that of the LRn by downsampling the image supplied from the motion-compensation processing section 412 and outputs the generated image to the adding section 414.

The adding section 414 generates a difference image which represents a difference between the LRn and an image output from the downsampling processing section 413 and outputs the generated difference image to the upsampling processing section 415.

The upsampling processing section 415 generates an image of the same resolution as that of the SR image by upsampling the difference image supplied from the adding section 414 and outputs the generated image to the reverse motion compensating section 416.

The reverse motion compensating section 416 performs a process described with reference to FIG. 17. That is, the inputs reverse motion compensating section 416 inputs (1) difference image input from the upsampling processing section 415, (2) super-resolution process area information (i.e., object area information) supplied from the area definition GUI 401 and (3) object motion vector (OMV) which is the object-based motion vector supplied from the motion vector detecting section 411. The object area information supplied from the object detection section 417 includes label information which represents to which the object each pixel which constitutes the SR image belongs.

The reverse motion compensating section 416 generates a difference image obtained by performing (4) reverse direction motion compensation illustrated in FIG. 17 through (1) reverse direction motion compensation to the difference image input from the upsampling processing section 415, on the basis of (2) object motion vector (OMV) supplied from the area definition GUI 401 which are super-resolution process area information (i.e., object area information) and (3) object-based motion vector supplied from the motion vector detecting section 411.

The process example in which all the object information is used is illustrated in FIG. 17. In the present embodiment, however, the process is executed only to an area corresponding to super-resolution processing area information (for example, the object area information) supplied from the area definition GUI 401.

Next, a detailed configuration and a process of the OMV precision check section 405 illustrated in FIG. 24 will be described with reference to FIG. 27. OMV precision check section 405 verifies precision of the object-based motion vector (OMV) generated by super-resolution processing executing section 404. If it is determined that the precision of the object-based motion vector (OMV) generated by super-resolution processing executing section 404 is high as a verification result, the OMV precision check section 405 controls to output a feedback value generated by super-resolution processing executing section 404 to the summing section 406.

The OMV precision check section 405 includes a motion-compensation processing section 421, a cost calculation section 422 and a determination processing section 423 as illustrated in FIG. 27. The OMV precision check section 405 inputs the OMV, the SR image, the LR image and super-resolution processing area information and verifies precision of the object-based motion vector (OMV) generated by super-resolution processing executing section 404. If it is determined that the OMV precision is high, a switch operation is performed so that the feedback value can be transmitted to the summing section 406.

The motion-compensation processing section 421 inputs the SR image from the SR image buffer 403 illustrated in FIG. 24 and also inputs the object-based motion vector (OMV) generated by super-resolution processing executing section 404. The motion-compensation processing section 421 generates a motion-compensated image (OMC SR image) which is motion-compensated by applying the object-based motion vector (OMV) to the SR image and outputs the image to the cost calculation section 422.

The cost calculation section 422 inputs thee motion-compensated image (OMC SR image) input from the motion-compensation processing section 421 and the upsampled LR image and calculates difference in the processing area as the cost. The cost calculation is similar to the process of the cost calculation section 303 in the OMV refinement section 234 described with reference to FIG. 20 in the second embodiment. That is, the cost calculation corresponding to the difference between the motion-compensated image and the upsampled LR image is performed. The cost calculation is performed in the following manner: first, a pixel value of a specified object area corresponding to the OMV to be processed included in the motion-compensated image and in the upsampled LR image; and then calculates the smallest square difference (SSD) or the normalized correlation (NCC) of the pixel value in the object in accordance with the equation described above.

As the value of the smallest square difference (SSD) is small, the cost is considered to be small. As the value of the normalized correlation (NCC) is small, the cost is considered to be small. The cost calculation section 422 outputs a calculated cost to the determination processing section 423. The determination processing section 423 compares the calculated cost with the predetermined threshold.

If the calculated cost is not more than the threshold, it is determined that the precision of the object-based motion vector (OMV) generated by super-resolution processing executing section 404 is high, and control is performed to output the feedback value generated by super-resolution processing executing section 404 to the summing section 406.

If the calculated cost is not less than the threshold, it is determined that the precision of the object-based motion vector (OMV) generated by super-resolution processing executing section 404 is low and output to the summing section 406 of the feedback value generated by super-resolution processing executing section 404 is halted.

Since plural super-resolution processing executing sections 404 are provided as illustrated in FIG. 24, output of low-precision feedback values to the summing section 406 is halted and only high-precision feedback values are output to the summing section 406. That is, only high-precision feedback value is used selectively for generation of the SR image.

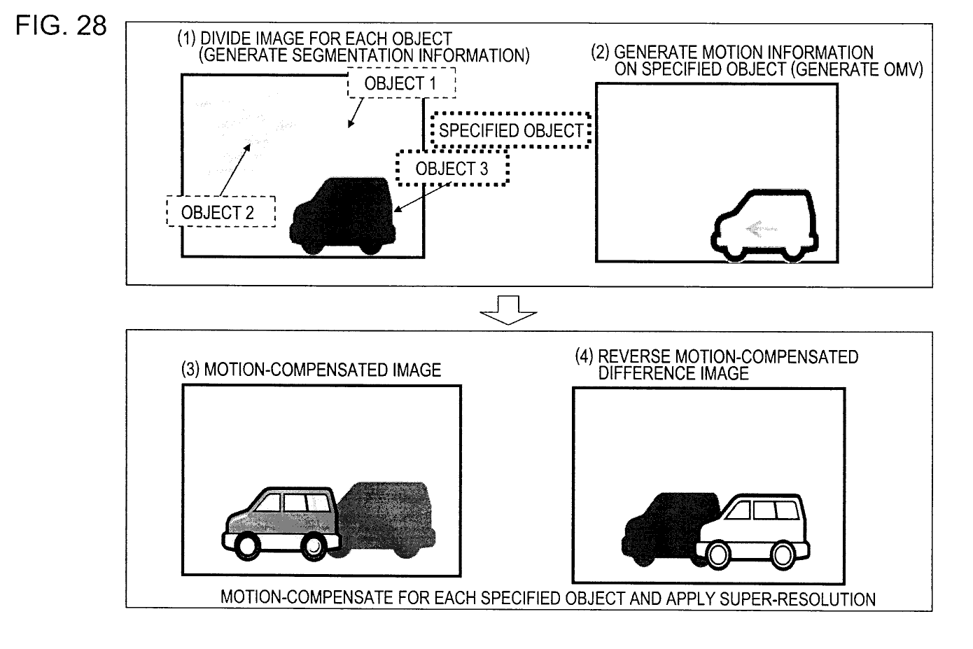

Super-resolution processing in accordance with the present embodiment can be executed only for the object specified by a user, e.g., the object 3 (automobile), using the area definition GUI 401 as illustrated in FIG. 28. As illustrated in FIG. 28(2), the motion vector detecting section 411 generates the object motion vector (OMV) which is the specified object-based motion vector.

(3) motion-compensated image (4) reverse motion-compensated difference image illustrated in FIG. 28 generated in super-resolution processing are generated by applying the object motion vector (OMV) which is the object-based motion vector only at a specified object area.

In the process of the embodiment of the invention, since the process is executed only for specified objects, which may increase process efficiency. As described with reference to FIGS. 24 to 27, the feedback values are selectively applied in accordance with the precision of the OMV generated by super-resolution processing executing section. With this configuration, the feedback value corresponding to high-precision OMV can be applied, which may enable generation of highly precise super-resolution images.

### (5) Exemplary Hardware Configuration of Image Processing Device

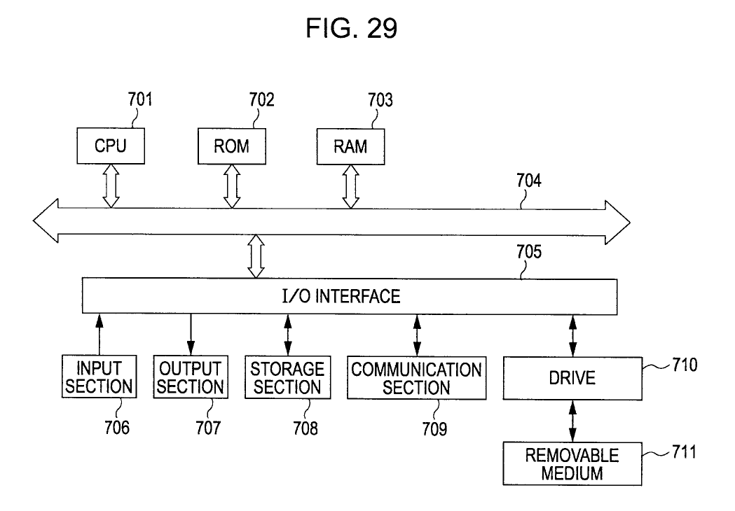

Finally, with reference to FIG. 29, an exemplary hardware configuration of a personal computer will be described as a one exemplary hardware configuration of the device that performs the above-described processes. A central processing unit (CPU) 701 performs various processes in accordance with the program stored in a read only memory (ROM) 702 or a storage section 708. For example, processing programs, such as super-resolution processing described in the foregoing embodiment, are executed. Programs to be executed by the CPU 701 and various data are stored in a random access memory (RAM) 703. The CPU 701, the ROM 702 and the RAM 703 are mutually connected by a bus 704.

The CPU 701 is connected to an I/O interface 705 via a bus 704. An input section 706 and an outputting section 707 are connected to the I/O interface 705. The input section 706 includes a keyboard, a mouse and a microphone. The output section 707 includes a display and a speaker. The CPU 701 executes various processes in accordance with instructions input from the input section 706 and outputs a processing result to the outputting section 707.

A storage section 708 connected to the I/O interface 705 includes a hard disks and stores and various data and programs to be executed by the CPU 701. A communication section 709 communicates with external devices via networks, such as the Internet and a local area network.

The drive 710 connected to the I/O interface 705 drives a removable media 711, such as a magnetic disc, an optical disc, a magneto-optical disc or a semiconductor memory, and acquires program and data recorded thereon. If necessary, the acquired program and data are transmitted to and stored in the storage section 708.

The invention has been described with reference to specified embodiments. However, it is obvious that person skilled in the art can make modification or substitution of the embodiments without departing from the scope of the invention. That is, the embodiment of the invention described above is illustrative only and not restrictive. In order to understand the scope of the invention, claims should be taken into consideration.

The series of processes described above can be implemented by hardware, software or a combination thereof. If the processes are implemented by software, a program recording the process sequence may be installed in a computer memory incorporated in dedicated hardware to perform the above-described processes. Alternatively, a program may be previously stored in a general-purpose computer that can perform various processes to perform the above-described processes. For example, the program can be recorded in advance in a recording medium. The program may be installed in the computer from the recording medium. The program may alternatively be received by the computer via a network, such as the local area network (LAN) and the Internet, and installed in an incorporated recording medium, such as a hard disk.

Various processes described in the specification may be performed in the described order. Alternatively, the processes may be performed in parallel or individually in accordance with throughput or necessary of the devices performing the processes. The term “system” used herein is a logical collection of plural devices, which are not necessarily placed in a single housing.

The present application contains subject matter related to that disclosed in Japanese Priority Patent Application JP 2008-296336 filed in the Japan Patent Office on Nov. 20, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device, comprising:
super-resolution processing executing section which inputs a low-resolution image and a super-resolution image and generates a difference image which represents a difference between the input images; and
an adding section which adds the difference image and the super-resolution image,
wherein super-resolution processing executing section includes a motion vector detecting section which detects an object-based motion vector which represents a motion between images of an object commonly included in the low-resolution image and the super-resolution image on an object basis, and generates the difference image using a motion-compensated image generated by applying the detected object-based motion vector to each object area.

2. The image processing device according to claim 1, wherein:
super-resolution processing executing section is configured by a plurality of super-resolution processing executing sections which generate difference images representing differences between a plurality of different low-resolution images and the super-resolution images; and
the adding section adds an output of a summing section which adds the super-resolution image and the plurality of difference images output from the plurality of super-resolution processing executing sections.

3. The image processing device according to claim 1 or 2, wherein:
super-resolution processing executing section further includes an object detection section which detects an object included in the super-resolution image and generates object area information that includes a label to identify an object to which each configuration pixel of the super-resolution image belongs; and
the motion vector detecting section detects an object-based motion vector on an object basis by applying the object area information generated by the object detection section.

4. The image processing device according to claim 1 or 2, wherein:
super-resolution processing executing section has an area definition GUI for inputting specification information regarding an area for which super-resolution processing is executed from the super-resolution image; and
the motion vector detecting section detects an object-based motion vector on an object basis by applying area definition information specified via the area definition GUI.

5. The image processing device according to claim 1 or 2, wherein:
the motion vector detecting section includes an object-based motion vector calculating section which calculates, on an object basis, an object-based motion vector which represents a motion between images of the object commonly included in the low-resolution image and the super-resolution image and an object-based motion vector refinement section which refines the object-based motion vector calculated by the object-based motion vector calculating section; and
the object-based motion vector refinement section modifies a constitution parameter of an object-based motion vector calculated by the object-based motion vector calculating section and generates a modified object-based motion vector, generates a low-cost modified object-based motion vector through a cost calculation on the basis of a difference between the low-resolution image and a motion-compensated image to which the modified object-based motion vector is applied, and outputs the generated low-cost modified object-based motion vector as a vector to be applied in generation of the difference image.

6. The image processing device according to claim 1 or 2, wherein:
the image processing device further includes an object-based motion vector inspecting section for inspecting precision of the object-based motion vector generated by super-resolution processing executing section,
the object-based motion vector inspecting section executes, with respect to the super-resolution image, a cost calculation on the basis of a difference between the low-resolution image and a motion-compensated image to which the object-based motion vector generated by super-resolution processing executing section is applied, the object-based motion vector inspecting section determines that the object-based motion vector has allowable precision when cost below a previously set threshold is calculated, and performs to output what as an object to be added in the adding section on the basis of the determination.

7. The image processing device according to claim 1 or 2, wherein super-resolution processing executing section generates the difference image using the motion-compensated image generated by applying the object-based motion vector to each object area and generates, when an occlusion area generated by a movement of an object exists in the difference image, a difference image with a pixel value 0 set for the occlusion area.

8. An image processing method which performs a super-resolution image generation process in an image processing device, the method comprising the steps of:
executing, by super-resolution processing executing section, super-resolution processing by inputting a low-resolution image and a super-resolution image for generating a difference image that represents a difference between the input images; and
adding, by an adding section, the difference image and the super-resolution image,
wherein super-resolution processing detects, on an object basis, the object-based motion vector which represents a motion between images of the object commonly included in the low-resolution image and the super-resolution image and generates the difference image by using a motion-compensated image generated by applying the detected object-based motion vector to each object area.

9. A program which causes a super-resolution image generation process to be executed in an image processing device, the process comprising the steps of:
executing super-resolution processing by causing super-resolution processing executing section to input a low-resolution image and a super-resolution image and generate a difference image that represents a difference between the input images; and
executing an adding process by causing an adding section to add the difference image and the super-resolution image,
wherein the step of executing super-resolution processing includes the steps of:
causing detection of, on an object basis, the object-based motion vector which represents a motion between images of the object commonly included in the low-resolution image and the super-resolution image; and
causing generation of the difference image by using a motion-compensated image generated by applying the detected object-based motion vector to each object area.
